(19) United States
(12) Patent Application Publication
(10) Pub. No.: US 2008/0224352 A1
(43) Pub. Date: Sep. 18, 2008

(54) SOLUTION CASTING PROCESS AND SYSTEM

(75) Inventors: Yoshiaki NARUKAWA, Minami-ashigara-shi (JP); Yoshitomo TERUI, Minami-ashigara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/046,141

(22) Filed: Mar. 11, 2008

(30) Foreign Application Priority Data
Mar. 12, 2007 (JP) 2007-061292

(51) Int. Cl. B29C 39/00; B29C 39/38

(52) U.S. Cl. 264/291; 425/470

(57) ABSTRACT

In a solution casting system, a casting die causes dope containing polymer and solvent to flow. A casting support belt is disposed movably under the casting die, for forming cast film from the dope being cast. A stripping roller strips the cast film having a self-supporting property to form self-supporting cast film. A first dryer stretches the self-supporting cast film, and while the self-supporting cast film is stretched, applies first gas with temperature T2 to the self-supporting cast film containing the solvent, to evaporate the solvent therefrom. A second dryer, after the self-supporting cast film is stretched, applies second gas with temperature T3 to the self-supporting cast film containing the solvent, to evaporate the solvent therefrom for obtaining polymer film. The first and second dryers satisfy a condition of:

0<T2−T3<50.

Also, a tentering machine contains the first and second dryers to stretch the self-supporting cast film.

### BACKGROUND OF THE INVENTION

1. Field of the Invention

The present invention relates to a solution casting process and system. More particularly, the present invention relates to a solution casting process and system in which a phenomenon of bowing of self-supporting cast film can be prevented to form optical film with a high optical quality.

2. Description Related to the Prior Art

Polymers are used as a support of polymer film contained in optical films or functional films, owing to advantageous characteristics, for example rigidity, non-flammability, and the like. A typical example of polymer is cellulose acylate, specifically, cellulose triacetate (TAC) having an average acetylation degree of 58.0-62.5%, for use widely in the field of photosensitive material. Also, the polymer film of the cellulose triacetate (TAC) is used as a protection film of a polarizing element, or an optical compensation film (view angle enlarging film or the like), any of those being incorporated in a liquid crystal display (LCD) panel. This is effective because of optically utilizing the highly isotropic property of the polymer film.

Examples of methods known in the field of production of the polymer film include extrusion and solution casting. The extrusion has a step of heating and melting polymer, before the polymer is extruded by an extruder to form the polymer film. This is advantageous in high productivity. A manufacturing cost of the extrusion is comparatively low. However, a shortcoming of the extrusion lies in difficulty in adjusting a thickness of the polymer film with precision. Die lines or streaks in a fine form are likely to occur on the polymer film. The extrusion is unsuitable for producing the optical film. In contrast with this, the solution casting has a step of casting a polymer solution on a support, the solution or dope containing polymer and solvent, so that a cast film is formed and comes to have a self-supporting property. A self-supporting cast film is stripped from the support. Web edges of the self-supporting cast film are clamped by clips in a tentering machine, to transport the self-supporting cast film in a transport direction. The self-supporting cast film during the transport is processed in film stretching, stress relaxation, and drying. When the self-supporting cast film is dried sufficiently, the polymer film is formed, and finally wound. The solution casting is capable of forming the polymer film having higher optical isotropic property, having higher uniformity in the thickness, and containing smaller foreign material than that formed by the extrusion. Accordingly, the solution casting is a widely used method of suitably producing the optical film.

The film stretching in the solution casting is to stretch the self-supporting cast film in a predetermined direction. The stress relaxation follows the film stretching, and releases stress remaining in the self-supporting cast film after the film stretching. The film stretching and the stress relaxation to the self-supporting cast film smoothen the surface of the polymer film as final product, adjust a retardation value and direction of a slow axis of the self-supporting cast film, to obtain high performance as optical element. It is likely that a phenomenon of bowing occurs in the self-supporting cast film in the film stretching and the stress relaxation by use of a tentering machine. It has been found recently that irregularity of the slow axis is likely to occur due to the bowing in the web width direction of the self-supporting cast film. High optical performance is desired in view of high quality of the liquid crystal display panel, for example, a high contrast ratio, high brightness of the screen and the like. To improve a producing method for the optical film requires reduction of the irregularity in the slow axis, and solution of other questions related to the optical performance. Typically in the protection film for the panel shaped polarizer, a very low value of a retardation Rth is desired in a range of 0-5 nm in order to prevent an elliptical form of a straight deflected light. Therefore, a regularly oriented form of the slow axis in the polymer film has been a difficult but important question in the production of the polymer film for the optical use according to the solution casting.

There are known ideas of prevention of the bowing of the self-supporting cast film in the solution casting. JP-A 2004-314529 discloses plural techniques for the prevention, one of which is to set the temperature of the web edges higher than that of the middle portion of the self-supporting cast film. A second of those is to set a residual solvent amount of the web edges higher than that of the middle portion. A third of those is to define a plurality of zones within the tentering machine or dryer with differences in the drying temperature.

However, the method of JP-A 2004-314529 has a problem in that control is necessary for distribution of the temperature, residual solvent amount and the like of the self-supporting cast film in the web width direction in the film stretching and the stress relaxation. This is so complex a control in the film stretching and the stress relaxation that time and cost for the manufacture are considerably large. Stability in the quality of the polymer film is difficult to obtain, so that the method is unsuitable for mass production. The method of JP-A 2004-314529, even capable of preventing the bowing, is not effective in suppressing irregularity in the polymer film which occurs in the film stretching and quickens degradation of the optical performance.

### SUMMARY OF THE INVENTION

In view of the foregoing problems, an object of the present invention is to provide a solution casting process and system in which a phenomenon of bowing of self-supporting cast film can be prevented to form optical film with a high optical quality.

In order to achieve the above and other objects and advantages of this invention, a solution casting process includes a flowing step of causing dope to flow on to a support, the dope containing polymer and solvent. In a cast film forming step, cast film is formed from the dope on the support. In a stripping step, the cast film having a self-supporting property is stripped to form self-supporting cast film. In a first drying step, the self-supporting cast film is stretched, and first gas with temperature Ta is applied to the self-supporting cast film containing the solvent, to evaporate the solvent therefrom. In a second drying step, after the self-supporting cast film is stretched, second gas with temperature Tb is applied to the self-supporting cast film containing the solvent, to evaporate the solvent therefrom for obtaining polymer film. The first and second drying steps satisfy a condition of:

0<Ta−Tb<50.

A first residual solvent amount of the self-supporting cast film in the stripping step is more than 40 wt. %. A second residual solvent amount of the self-supporting cast film at a start of the first drying step of stretching and evaporation is less than 25 wt. %, and a difference between the first and second residual solvent amounts is more than 20 wt. %.

Preferably, 3<Ta−Tb<30.

In a preferable embodiment, 5<Ta−Tb<15.

Furthermore, the self-supporting cast film is preheated between the stripping step and the first drying step.

The first and second drying steps are carried out in a tentering machine.

The tentering machine includes first, second and third zones arranged sequentially. In the first zone, web edge portions of the self-supporting cast film in entry are supported for transport, and the first drying step is carried out in the second zone, and the second drying step is carried out in the third zone.

Furthermore, the self-supporting cast film is preheated in the first zone. A web width of the self-supporting cast film increases from a first width to a second width in the second zone, and is equal to the second width in the third zone.

Furthermore, gas is blown to the self-supporting cast film after the stripping step and upstream from the tentering machine, to evaporate the solvent preliminarily.

Furthermore, there is a subsequent drying step of drying the polymer film after the second drying step.

Furthermore, a web edge portion of the polymer film is slitted after the second drying step.

A residual solvent amount of the polymer film from the second drying step is equal to or less than 5 wt. %.

In one aspect of the invention, a solution casting system includes a casting die for causing dope containing polymer and solvent to flow. A support is disposed movably under the casting die, for forming cast film from the dope being cast. A stripping mechanism strips the cast film having a self-supporting property to form self-supporting cast film. A first dryer stretches the self-supporting cast film, and applies first gas with temperature Ta to the self-supporting cast film containing the solvent, to evaporate the solvent therefrom. A second dryer, after the self-supporting cast film is stretched, applies second gas with temperature Tb to the self-supporting cast film containing the solvent, to evaporate the solvent therefrom for obtaining polymer film. The first and second dryers satisfy a condition of:

0<Ta−Tb<50.

Also, a tentering machine contains the first and second dryers to stretch the self-supporting cast film.

The tentering machine includes first, second and third zones arranged sequentially. In the first zone, web edge portions of the self-supporting cast film in entry are supported for transport, and the second zone has the first dryer, and the third zone has the second dryer.

Accordingly, a phenomenon of bowing of self-supporting cast film can be prevented to form optical film with a high optical quality, because solvent is evaporated from self-supporting cast film at the two temperature levels in the stretching step.

### BRIEF DESCRIPTION OF THE DRAWINGS

The above objects and advantages of the present invention will become more apparent from the following detailed description when read in connection with the accompanying drawings, in which:

FIG. 1 is a chart illustrating a flow of sequential steps in operation of a solution casting system of the invention;

FIG. 2 is an explanatory view schematically illustrating the solution casting system;

FIG. 3 is an explanatory view illustrating a tentering machine containing three zones for drying according to the invention.

### DETAILED DESCRIPTION OF THE PREFERRED EMBODIMENT(S) OF THE PRESENT INVENTION

[Raw Material]

For polymer in the dope, cellulose acylate can be preferably used for obtaining high transparency. A specifically preferable example of the cellulose acylate is cellulose triacetate (TAC as triacetyl cellulose). Preferable examples of cellulose acylates satisfy all of the conditions I-III:

2.5≦A+B≦3.0 I

0≦A≦3.0 II

0≦B≦2.9 III

where A and B represent a degree of substitution of an acyl group (—CO—R) formed by substituting hydroxy groups in cellulose. A represents a degree of substitution of an acetyl group formed by substituting hydroxy groups in cellulose. B represents a total degree of substitution of acyl groups having 3-22 carbon atoms. Preferably, 90 wt. % or more of the entirety of TAC should be particles of 0.1-4 mm. Note that the polymer in the invention is not limited to cellulose acylate.

The cellulose is constructed by glucose units making a beta-1,4 bond, and each glucose unit has a liberated hydroxy group at second, third and sixth positions. Cellulose acylate is a polymer in which part or whole of the hydroxy groups are esterified so that the hydrogen is substituted by acyl groups having two or more carbon atoms. The degree of substitution for the acyl groups in cellulose acylate is a degree of esterification at second, third or sixth position in cellulose. Accordingly, when 100% of the hydroxy group at the same position is substituted, the degree of substitution at this position is 1.

The total degree of substitution DS2+DS3+DS6 for the acyl groups at the second, third or sixth positions is in the range of 2.00-3.00, preferably 2.22-2.90, and in particular preferably 2.40-2.88. The sign DS2 is a degree of substitution for the acyl groups at the second position in hydroxy groups in the glucose unit. The signs DS3 and DS6 are degrees of substitution for the acyl groups at respectively the third and sixth positions in hydroxy groups in the glucose unit. Further, a ratio DS6/(DS2+DS3+DS6) is preferably 0.28 or more, and particularly 0.30 or more, and especially in the range of 0.31-0.34.

An acyl group of only one example may be contained in the cellulose acylate of the invention. However, cellulose acylate may contain acyl groups of two or more examples. If two or more acyl groups are contained, one of the plural acyl groups should be preferably an acetyl group. Let DSA be a total degree of substitution for the acetyl groups. Let DSB be a total degree of substitution for other acyl groups at the second, third or sixth positions than the acetyl groups. The value DSA+DSB is preferably in the range of 2.22-2.90, and particularly in the range of 2.40-2.88.

Further, the DSB is preferably at least 0.30, and especially at least 0.70. Furthermore, in the DSB, the percentage of a substituent at the sixth position is preferably at least 20%, preferably at least 25%, especially at least 30% and most especially at least 33%. Further, the value DSA+DSB at the sixth position is at least 0.75, preferably at least 0.80, and especially at least 0.85. Cellulose acylate satisfying the above conditions can be used to prepare a solution or dope having a preferably high solubility. Especially, when chlorine-free type organic solvent is used, the adequate dope can be prepared. Also, the dope can be prepared to have a low viscosity, and high solubility, and the suitability for filtration becomes higher.

Cellulose to produce cellulose acylates can be obtained any one of linter cotton and pulp cotton, but preferably can be obtained from linter cotton.

Examples of acyl groups in cellulose acylates having two or more carbon atoms can be aliphatic groups, aryl groups, and the like. For example, cellulose acylates may be alkyl carbonyl esters, alkenyl carbonyl esters, aromatic carbonyl esters, aromatic alkyl carbonyl esters, and the like of cellulose, and can further contain a substitution group. Preferable examples of groups include: propionyl, butanoyl, pentanoyl, hexanoyl, octanoyl, decanoyl, dodecanoyl, tridecanoyl, tetradecanoyl, hexadecanoyl, octadecanoyl, iso-butanoyl, tert-butanoyl, cyclohexane carbonyl, oleoyl, benzoyl, naphthyl carbonyl, and cinnamoyl. Among those, particularly preferable groups are propionyl, butanoyl, dodecanoyl, octadecanoyl, tert-butanoyl, oleoyl, benzoyl, naphthyl carbonyl, and cinnamoyl. Further, specifically preferable groups are propionyl and butanoyl.

Solvent as raw material of dope is preferably an organic compound in which polymer is soluble. The term of dope in the invention is used as mixture obtained by dissolution or dispersion of polymer in a solvent. Examples of solvents for preparing the dope include:

aromatic hydrocarbons, such as benzene and toluene;

halogenated hydrocarbons, such as dichloromethane and chlorobenzene;

alcohols, such as methanol, ethanol, n-propanol, n-butanol, and diethylene glycol;

ketones, such as acetone and methyl ethyl ketone;

esters, such as methyl acetate, ethyl acetate, and propyl acetate;

ethers, such as tetrahydrofuran and methyl cellosolve.

Halogenated hydrocarbons containing 1-7 carbon atoms are preferably used, for example, dichloromethane. Specifically, it is preferable in a mixed solvent to mix one or more alcohols containing 1-5 carbon atoms with the dichloromethane, for the purpose of high solubility, easy separability from a support for casting, mechanical strength of film material, and various optical characteristics of cellulose triacetate (TAC). Such alcohols are contained in the mixed solvent preferably in a range of 2-25 wt. %, and desirably in a range of 5-20 wt. %. Preferable examples of alcohols are methanol, ethanol, n-propanol, isopropanol, n-butanol and the like. Among those, specifically preferable alcohols are methanol, ethanol, n-butanol, and mixture of two or more of them.

For the purpose of minimizing influence to environment, solvents not containing dichloromethane are effectively used in the publicly suggested manner. Examples of compounds useful to this end are ethers having 4-12 carbon atoms, ketones having 3-12 carbon atoms, esters having 3-12 carbon atoms, and alcohols having 1-12 carbon atoms. Two or more compounds can be mixed as mixed solvents. Specifically preferable mixed solvents are mixtures of at least two of methyl acetate, acetone, ethanol and n-butanol. Ethers, ketones, esters and alcohols of the examples may have a cyclic structure. Compounds having two or more functional groups of —O—, —CO—, —COO— and —OH, namely groups of ethers, ketones, esters and alcohols, can be used as a solvent.

Details of cellulose acylates are according to various relevant techniques suggested in JP-A 2005-104148. Those examples and their various features can be used in the present invention.

I. Specific Examples of Cellulose Acylates

Suggested in JP A 57-182737 (corresponding to U.S. Pat. No. 4,499,043), JP A 10-45803 (corresponding to U.S. Pat. No. 5,856,468), JP A 11-269304 (corresponding to U.S. Pat. No. 6,139,785), JP A 8-231761, JP A 10-60170, JP A 9-40792, JP A 11-5851, JP A 9-90101, JP A 4-277530, JP A 11-292989, JP A 2000-131524, and JP A 2000-137115.

II. Specific Examples of Solvents for Esters and their Dissolution

Suggested in JP A 10-324774, JP A 8-152514, JP A 10-330538, JP A 9-95538 (corresponding to U.S. Pat. No. 5,663,310), JP A 9-95557 (corresponding to U.S. Pat. No. 5,705,632), JP A 10-235664 (corresponding to U.S. Pat. No. 6,036,913), JP A 2000-63534, JP A 11-21379, JP A 10-182853, JP A 10-278056, JP A 10-279702, JP A 10-323853 (corresponding to U.S. Pat. No. 6,036,913), JP A 10-237186, JP A 11-60807, JP A 11-152342, JP A 11-292988, JP A 11-60752, JP A 2000-95876, and JP A 2000-95877.

Uses of various materials in relation to the polymer have been suggested in JP-A 2005-104148, including solvents, plasticizers, deterioration inhibitors, ultraviolet (UV) absorbers, lubricants, stripping accelerators, optical anisotropy control agents, retardation control agents, dyes, release agents, and other additives.

I. Plasticizers

Suggested in JP A 4-227941, JP A 5-194788, JP A 60-250053, JP A 6-16869, JP A 5-271471, JP A 7-286068, JP A 5-5047 (corresponding to U.S. Pat. No. 5,279,659), JP A 11-80381, JP A 7-20317, JP A 8-57879, JP A 10-152568, and JP A 10-120824.

II. Deterioration Inhibitors and UV Absorbers

Suggested in JP A 60-235852, JP A 3-199201, JP A 5-190707, JP A 5-194789, JP A 5-197073, JP A 5-271471, JP A 6-107854, JP A 6-118233, JP A 6-148430, JP A 7-11055, JP A 7-11056, JP A 8-29619, JP A 8-239509 (corresponding to U.S. Pat. No. 5,806,834), JP A 2000-204173, and JP A 2000-193821.

[Retardation Control Agents]

It is preferred in the present invention to use a retardation control agent to control the preferred retardation value. Preferable examples of the retardation control agents are rod-shape or discotic compounds. As to the rod-shaped or discotic compounds, a compounds having at least two aromatic rings may be used. Adding amount of the retardation control agent comprising a rod-shaped compound is preferably 0.1-30 parts by mass and more preferably, 0.5-20 parts by mass to 100 parts by mass of polymer components of cellulose acylate.

A discotic retardation control agent is added within a range of preferably 0.05-20 parts by mass, more preferably 1.0-15 parts by mass and still more preferably, 3.0-10 parts by mass to 100 parts by mass of polymer components of the cellulose acylate.

A discotic compound is better than a rod-shaped compound in view of a property of controlling the Rth retardation and therefore, it is preferably used especially when a high Rth retardation is necessary. Two or more retardation control agents may be used together.

The retardation control agent comprising a rod-shaped or discotic compound preferably has a maximum absorption within a wavelength region of 250-400 nm and substantially does not have absorption in visible area.

With regard to a discotic compound, a compound having at least two aromatic rings may be used.

In this specification, “aromatic ring” can be an aromatic hetero ring in addition to aromatic hydrocarbon ring.

An aromatic hydrocarbon ring is preferably a six-membered ring (that is a benzene ring).

An aromatic hetero ring is usually an unsaturated hetero ring. The aromatic hetero ring is preferably five-membered ring, six-membered ring or seven-membered ring and more preferably, five-membered ring or six-membered ring. Usually, an aromatic hetero ring has the highest numbers of double bonds. With regard to a hetero atom, the preferred examples are nitrogen atom, oxygen atom and sulfur atom, and nitrogen atom is preferable in particular. Examples of the aromatic hetero ring include furan ring, thiophene ring, pyrrole ring, oxazole ring, isoxazole ring, thiazole ring, isothiazole ring, imidazole ring, pyrazole ring, furazan ring, triazole ring, pyran ring, pyridine ring, pyridazine ring, pyrimidine ring, pyrazine ring and 1,3,5-triazine ring.

Preferably, a benzene ring, fused benzene ring, and biphenyl ring are used. Among those, 1,3,5-triazine ring is desirable. Heterocyclic compounds 1 and 2 are particularly preferable, as indicated below.

Heterocyclic Compound 1

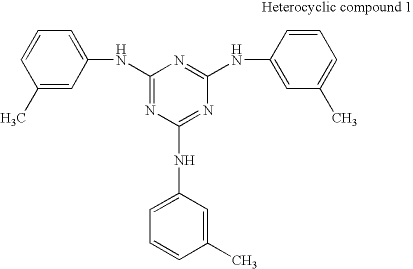

Heterocyclic Compound 2

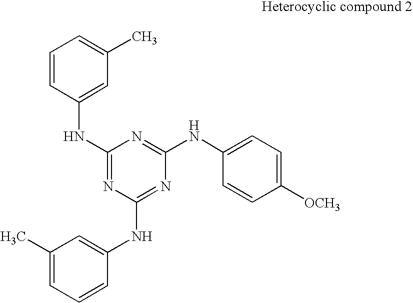

[Production of Dope]

At first, dope is produced by use of the above raw materials. A dope producing system includes a solvent tank or reservoir, a dissolving tank or reservoir, a hopper, and an additive tank or reservoir. The dissolving tank mixes TAC and the like with the solvent. The hopper supplies the TAC. The additive tank stores additives. Furthermore, the dope producing system includes a heater, a temperature adjuster, and a filtration device. The temperature adjuster adjusts temperature of the dope. The heater applies heat to swollen liquid which will be described later. The dope producing system also has a solvent recovery device and a solvent refiner. A solution casting system 40 is positioned downstream from the dope producing system. A storage reservoir or stock tank 39 of the solution casting system 40 is connected with the dope producing system.

At first, a valve is set in its open position, to introduce a solvent to the dissolving tank from the solvent tank. Then TAC stored in the hopper is introduced to the dissolving tank in a manner of controlling an amount. Also, a valve is shifted between open and closed positions, to introduce additive solution to the dissolving tank from the additive tank at an amount suitable for use. Note that it is possible to deliver an additive to the dissolving tank in a normally liquid phase at a room temperature, unlike the solution of the initially solid additive in a solvent. Furthermore, if an additive is solid at a room temperature, the additive can be delivered to the dissolving tank by use of a hopper for the solid additive. To use a plurality of additives, a plurality of solutions can be prepared with the additives mixed therewith, and can be mixed up in the additive tank. Also, a multi conduit delivery can be used, in which a plurality of additive reservoirs are used for storing solutions of additives in solvents, and plural conduits are connected for delivery of the additive solutions to the dissolving tank.

According to the above description, the process of delivery to the dissolving tank or reservoir is in a sequence of solvent, TAC and then additives. However, the process can be according to a sequence different from this. It is possible to introduce solvent of a preferred amount after measuring and introducing the TAC to the dissolving tank. Furthermore, additives may not be prepared in the dissolving tank initially. It is possible in subsequent steps to mix additives to a composition containing TAC and solvent.

A jacket is disposed on an outside of the dissolving tank or reservoir. A first stirrer or anchor stirrer is contained in the dissolving reservoir. A motor drives the anchor stirrer. A second stirrer or dissolver stirrer is contained in the dissolving reservoir. A motor drives the dissolver stirrer. In the embodiment, the anchor stirrer is a stirrer with an anchor blade. The dissolver stirrer is an eccentric type. Heat exchange medium of a conditioned temperature is caused to flow in the jacket, to condition its inner temperature at a constant level in a range from −10 to 55 deg. C. The selective use of such plural types of stirrers is effective in obtaining swollen solution in which TAC is swollen in the solvent.

A pump delivers the swollen liquid to the heater. It is preferable that conduits with a jacket are incorporated in the heater. Also, a structure for pressurizing the swollen liquid is preferably associated with the heater. A dope is obtained by use of the swollen liquid conditioned in application of heat or application of pressure and heat, and by dissolving TAC or other solute in a solvent. This method is referred to as thermal dissolution. During the dissolution, the swollen liquid should be kept at a temperature of 50-120 deg. C. Also, a process of cooling dissolution can be used, in which the swollen liquid is cooled at a temperature between −30 and −100 deg. C. The TAC can be dissolved in the solvent sufficiently by suitable selection of the thermal dissolution and cooling dissolution. The temperature adjuster conditions the dope at the room temperature. The filtration device filtrates the dope to eliminate impurity. In the filtration device, a filter has a preferable pore diameter of which an average is 100 microns or less. A filtration flow rate is preferably 50 liters/mm².hr or more. Filtrated dope 11 or initial solution is caused to flow to the storage reservoir 39 of the solution casting system 40, and stored.

The above-described method of preparing the swollen liquid and then forming the dope from the swollen liquid has a problem in that required time is very long according to the high density of the TAC, to raise the manufacturing cost. In view of this, dope of a low density can be initially prepared in comparison with the target density, before condensation to obtain dope with the target density. To this end, a flash evaporator or flash device is supplied with the dope filtrated by the filtration device. Part of the solvent in the dope is evaporated in the flash device for condensation. The solvent in the gas phase is liquefied by a condenser (not shown). A solvent recovery device collects the gaseous solvent. A refiner is supplied with the collected solvent, and refines a solvent ready for use in preparing the dope. The reuse of the dope is effective in reducing the manufacturing cost.

After the condensation, the dope 11 is caused to flow from the flash evaporator or flash device by a pump. It is preferable to defoam the dope 11 from the flash device to eliminate bubbles. Any known defoaming methods can be used for removing bubbles. In the embodiment, ultrasonic defoaming is used to apply ultrasonic waves to the dope 11 immediately obtained from the flash device. Then a filtration device is supplied with the dope 11, and removes foreign materials. The dope 11 can be preferably conditioned at a temperature of 0-200 deg. C. The dope 11 is sent to the storage reservoir 39, and stored readily for casting.

According to the embodiment, the dope 11 containing TAC at a density of equal to or more than 5 wt. % and equal to or less than 40 wt. % is obtained. A density of the TAC in the dope 11 is preferably equal to or more than 15 wt. % and equal to or less than 30 wt. %, and desirably equal to or more than 17 wt. % and equal to or less than 25 wt. %. A density of the additive, of which a main content is a plasticizer, in the dope is preferably equal to or more than 1 wt. % and equal to or less than 20 wt. % in 100 wt. % of the solid content in the dope.

In the dope production from cellulose triacetate, various techniques suggested in JP-A 2005-104148 for dissolution of materials and additives, filtration, elimination of bubbles, mixing of additives can be used.

No. 1. Dissolution Related to Casting

Suggested in JP A 9-95544 (corresponding to U.S. Pat. No. 5,663,310), JP A 10-45950, JP A 10-95854 (corresponding to U.S. Pat. No. 5,783,121), and JP A 2000-53784.

No. 2. Specific Preparing Methods of Solutions

Suggested in JP A 11-310640 (corresponding to U.S. Pat. No. 6,211,358), JP A 11-323017, JP A 11-302388, and JP A 2000-273184.

No. 3. Condensation of Solutions

Suggested in JP A 4-259511; U.S. Pat. No. 2,541,012, U.S. Pat. No. 2,858,229, U.S. Pat. No. 4,414,341, and U.S. Pat. No. 4,504,355.

[Film Production]

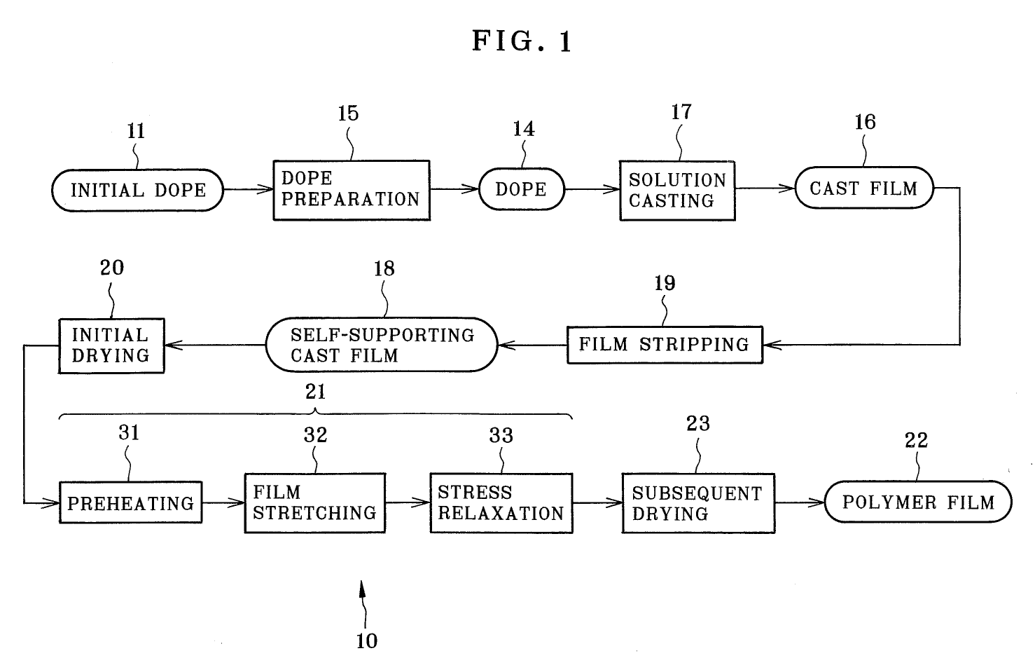

A solution casting process 10 for polymer film production for producing polymer film from the dope 11 is described now. In FIG. 1, the solution casting process 10 has steps of dope preparation 15, solution casting 17, film stripping 19, initial drying 20 by air blowing or first drying step, tension drying 21, and subsequent drying 23 or second drying step in a downstream dryer 47. In the dope preparation 15, dope 14 is prepared from the dope 11 as initial solution. In the solution casting 17, cast film 16 is formed by casting the dope 14 on a support. In the film stripping 19, self-supporting cast film 18 is obtained by stripping the cast film 16 from the support when its self-supporting property is developed. In the initial drying 20, the self-supporting cast film 18 is processed in evaporation of solvent. In the tension drying 21, the self-supporting cast film 18 is stretched and processed in evaporation of solvent simultaneously. In the subsequent drying 23, polymer film 22 is obtained by sufficiently evaporating solvent from the self-supporting cast film 18. Also, a step of film winding can be added for winding the polymer film 22.

The tension drying 21, in connection with a tentering machine to be described later, has steps of preheating 31, film stretching 32, and stress relaxation 33. A main purpose of the preheating 31 is to dry the self-supporting cast film 18 before the film stretching 32 and to preheat the self-supporting cast film 18 for the film stretching 32.

In the film stretching 32, the self-supporting cast film 18 is dried while stretched in a predetermined direction. A main purpose of the film stretching 32 is to impart and adjust optical property of retardation values and the like and to flatten a surface of the self-supporting cast film 18 with prevention of bowing by simultaneous stretching and drying.

The retardation as a term used herein is one of in-plane retardation value (Re) and retardation value (Rth) in the thickness direction. The following is definitions of those values.

Re=|nMD−nTD|×d

Rth=[(nMD+nTD)/2−nTH]×d

where nMD is a refractive index in the casting direction or longitudinal direction of the polymer film;

nTD is a refractive index in the web width direction of the polymer film;

nTH is a refractive index in the film thickness direction of the polymer film;

d is a thickness of the polymer film in nm.

In the stress relaxation 33, the self-supporting cast film 18 is dried without stretching in the web width direction. A main purpose of the stress relaxation 33 is to eliminate irregularity and remaining stress caused in the self-supporting cast film 18 by the film stretching 32, and to prevent bowing. Note that the stress relaxation 33 may be carried out while the web edges of the self-supporting cast film 18 are clamped, or while the web edges are free from clamping.

The bowing is a phenomenon created typically when web edges of the self-supporting cast film 18 are clamped and transported longitudinally. A delay occurs in the middle portion of the self-supporting cast film 18 in comparison with the web edges due to the transport by clamping those. The delay also remains in the self-supporting cast film 18 when tension applied to the web edges discontinues. The bowing created by this delay results in irregularity in the slow axis of the self-supporting cast film 18.

[Solution Casting]

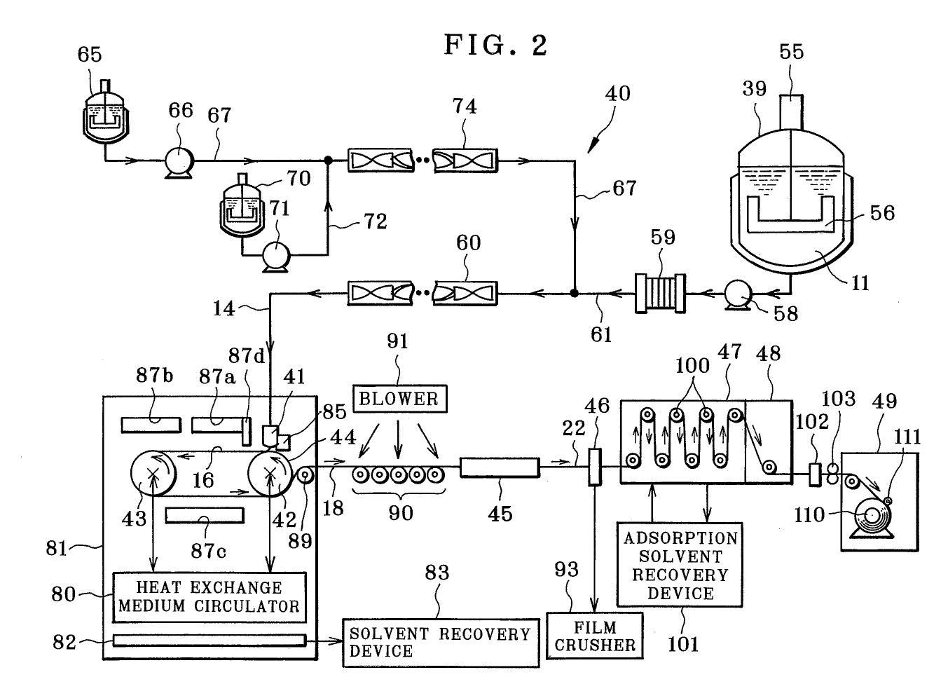

Production of the polymer film 22 from the dope 11 is described next. In FIG. 2, the solution casting system 40 is illustrated. The invention is not limited to the system in FIG. 2. The solution casting system 40 includes the storage reservoir 39, a casting die 41, a casting support belt 44, a tension drying chamber 45, a web edge slitter 46, a downstream dryer 47, a cooler 48 in a cooling chamber, and a winder 49 in a winding chamber. There are drive rollers 42 and 43 about which the casting support belt 44 turns. The tension drying chamber 45 is for the film stretching 32 and the stress relaxation 33. The web edge slitter 46 is for web edge slitting. The downstream dryer 47 is for the subsequent drying 23.

A stirrer 56 is incorporated in the storage reservoir 39. A motor 55 rotates the stirrer 56. A conduit 61 connects the storage reservoir 39 to the casting die 41. Plural elements are associated with the conduit 61, including a pump 58, a filtration device 59 and a static mixer 60.

A first reservoir 65 stores the matte agent solution. The matte agent solution contains solvent, polymer and additives which constitute the dope 11, and is prepared for easy mixture with the dope 11. A conduit 67 extends from the first reservoir 65 for flow. A pump 66 is connected between portions of the conduit 67. Preferable examples of the matte agent are silica, alumina and the like. Density of the matte agent solution is not limited, but may be preferably in a range of 0.01-0.50 wt. %.

A second reservoir 70 stores solution of UV absorber. The UV absorber is prepared to contain a solvent, polymer, and additives, and characteristically miscible with the dope 11. A conduit 72 is connected to extend from the second reservoir 70. A pump 71 is associated with the conduit 72. The conduit 72 is connected with the conduit 67 where the matte agent solution flows. A static mixer 74 is associated with the conduit 67 and is downstream from the conduit 72. Also, the conduit 67, where the dope 11 flows downstream from the static mixer 74, is connected with the conduit 61. Examples of the UV absorber preferable in the invention are not limited, but can be benzotriazol, benzophenone and the like. Preferable density of the UV absorber can be equal to or more than 0.1 wt. % and equal to or less than 3.0 wt. %.

The matte agent solution flows through the conduit 67 and is mixed with the ultraviolet absorber solution. Then the matte agent solution is stirred by the static mixer 74. The obtained stirred solution is referred to as an additive solution.

The additive solution is mixed with the dope 11 or initial solution flowing through the conduit 61. The solution is stirred by the static mixer 60 and uniformized. Thus, the dope 14 is obtained.

A preferable material of the casting die 41 can be stainless steel of a type of precipitation hardening. In view of heat resistance, the material can have a coefficient of thermal expansion of 2×10⁻⁵ (/deg. C.) or less. Desirably, a corrosion resistance of the material should be equal to that of SUS 316 steel according to forced corrosion test in electrolytic aqueous solution. Also, the material of the casting die 41 has the corrosion resistance sufficient for prevention of pitting on the gas-liquid interface even after dipping in a liquid mixture of dichloromethane, methanol and water for three (3) months. The casting die 41 is created by cutting and scraping a steel block which has been preserved for one (1) month or more after being molded. This preservation is effective in regularizing a surface condition of the dope 14 flowing in the casting die 41, and preventing occurrence of streaks. Surfaces of the casting die 41 to contact the liquid are formed with precision to have a surface roughness of 1 micron or less, and a degree of straightness of 1 micron per meter or less in any direction. A clearance of the die slot is adjustable in a range of 0.5-3.5 mm by an automatic adjustment. Preferable corner portions at the end of the die lip to contact the liquid are shaped so as to set a radius of curvature R at 50 microns or less in the whole width of the slot. A preferable shear rate of the dope 14 inside the casting die 41 is in a range of 1-5,000 (1/sec).

A casting width of the casting die 41 is not limited to a certain size. A preferable casting width of the casting die 41 can be preferably 1.1-2.0 times as much as a web width of the polymer film as a final product. A temperature adjuster is preferably associated with the casting die 41 for use in the course of casting to maintain a predetermined temperature. A preferable example of the casting die 41 is a coat hanger type. Thickness adjusting die bolts or heat bolts can be arranged at a given pitch in the web width direction, and are preferably adapted to automatic adjustment of the thickness of casting of the casting die 41. The die bolts are constructed with a profile set up according to a flow amount of the pump 58 or gear pump by a stored program. Also, an infrared thickness meter (not shown) can be installed in the solution casting system 40, for feedback control according to an adjusting program based on the profile of the infrared thickness meter. A difference between any two points which are on the polymer film, except for the die edges for the casting, is preferably equal to or less than 1 micron. The greatest difference between maximum and minimum values of the thickness in the width direction is preferably set equal to or less than 3 microns. Precision in the thickness is preferably so determined that an average error in the thickness of the cast film is equal to or less than 1.5 microns.

A hardened layer or case can be preferably formed on the end of the slot lip of the casting die 41. Various methods for forming the hardened layer or case can be used, including application of a ceramic coating, a hard chromium plating, and processing of nitriding. In case of using the ceramic coating, the material of the ceramic coating should have suitability for grinding, low porosity, low fragility, high resistance to corrosion, suitability for adhesion to the casting die 41, and property of small adhesion to the dope. Specifically, WC (tungsten carbide), Al₂O₃, TiN, Cr₂O₃ and the like can be used, among which WC is particularly preferable. A thermal spray process can be used for applying a WC coating.

Specifically, a solvent delivery device (not shown) can be connected to an end of the die slot of the casting die 41. It is possible locally to prevent drying and solidification of the dope 14 at the end of the die slot. A solvent for imparting solubility to the dope 14 can be supplied to a gas-liquid-solid interface between an end of the casting bead, the die slot, and ambient gas. An example of the solvent can be a mixed solvent containing 86.5 parts by weight of dichloromethane, 13 parts by weight of methanol, and 0.5 part by weight of n-butanol. The mixed solvent should be delivered to each of two slot ends at a range of 0.1-1.0 ml per minute for the purpose of preventing unwanted mixture of foreign material in the bead or the cast film. A pump for delivering the mixed solvent should have a fluctuation ratio of 5% or lower.

Between the drive rollers 42 and 43, the casting support belt 44 extends for turning under the casting die 41. A driving mechanism (not shown) causes the drive rollers 42 and 43 to rotate, so the casting support belt 44 circulates endlessly. A preferable range of a casting speed, namely a moving speed of the casting support belt 44 is 10-200 m/min. A heat exchange medium circulator 80 should be preferably associated with the drive rollers 42 and 43 for controlling a surface temperature of the casting support belt 44. A preferable range of the surface temperature of the casting support belt 44 is from −20 to 40 deg. C. A flow conduit (not shown) for a heat exchange medium is formed through the drive rollers 42 and 43, and keeps the drive rollers 42 and 43 at a target temperature by flow of the heat exchange medium at a prescribed temperature.

A width of the casting support belt 44 is not limited to a certain size. A preferable width of the casting support belt 44 can be 1.1-2.0 times as much as a casting width of the dope 14. A length of the casting support belt 44 is preferably 20-200 meters. A thickness of the casting support belt 44 is 0.5-2.5 mm. A surface roughness of the casting support belt 44 is 0.05 micron or less owing to polishing the band surface. The material of the casting support belt 44 is preferably stainless steel, for example SUS 316, and has sufficient strength and resistance to corrosion. Irregularity of the thickness of the casting support belt 44 is preferably 0.5% or less.

The drive rollers 42 and 43 can be a drum-shaped support for casting in place of the casting support belt 44. It is preferable to rotate the drive rollers 42 and 43 with such high precision that fluctuation of rotations is as small as 0.2 mm or lower. An average surface roughness of the drive rollers 42 and 43 can be 0.01 micron or less. Thus, the drive rollers 42 and 43 are finished by chrome plating or the like for imparting sufficient hardness and durability. It is necessary to minimize the surface defects of the support which may be the casting support belt 44 or the drive rollers 42 and 43. Specifically, an amount of a pinhole in a size of 30 microns or more should be zero. An amount of a pinhole in a size equal to or more than 10 microns and less than 30 microns should be one (1) or less per sq. meter. An amount of a pinhole in a size less than 10 microns should be two (2) or less per sq. meter.

A casting chamber 81 contains the casting die 41, the casting support belt 44, and also a temperature adjuster (not shown) and a solvent condenser 82. The temperature adjuster adjusts the inner temperature of the casting chamber 81 for conditioning at a constant level. The solvent condenser 82 is supplied with gaseous solvent derived by evaporation, and liquefies the solvent. A solvent recovery device 83 is disposed outside the casting chamber 81, and recovers the solvent. It is preferable that in the course of casting, a decompressor 85 conditions the pressure in such a manner that the pressure on the rear side of the bead of the dope 27 or on the upstream side is controlled and lowered.

Gas flow ducts 87a, 87b and 87c are formed through the casting chamber 81, and disposed near to the surface of the casting support belt 44 for evaporating solvent from the cast film 16. A separation panel 87d or seal is preferably positioned downstream from the casting die 41. The separation panel 87d blocks a flow of the evaporative gas, and can prevent fluctuation of the surface of the cast film 16 immediately after the casting. A transport path extends in the casting chamber 81 for transporting the cast film 16 while the casting support belt 44 turns. A stripping roller 89 as stripping mechanism is disposed at a downstream end of the transport path. The cast film 16 transported by the casting support belt 44 is stripped by the stripping roller 89, which causes the self-supporting cast film 18 to move out of the casting chamber 81.

A transition region 90 for the initial drying 20 is disposed between the casting chamber 81 and the tension drying chamber 45. An initial drying fan or blower 91 is disposed in the transition region 90. The tension drying chamber 45 processes the self-supporting cast film 18 in predetermined conditions of drying and stretching, to form the polymer film 22. A film crusher 93 is connected with the web edge slitter 46 downstream from the tension drying chamber 45, for crushing cut portions of web edges of the polymer film 22 as chips. The tension drying chamber 45 will be described later in detail.

A great number of transport rollers 100 are contained in the downstream dryer 47. In the downstream dryer 47, an adsorption solvent recovery device 101 recovers gaseous solvent evaporated from the polymer film 22. The cooler 48 is disposed downstream from the downstream dryer 47. Furthermore, a fluidity adjusting chamber (not shown) may be disposed between the downstream dryer 47 and the cooler 48. Then a static elimination bar 102 adjusts the voltage of the polymer film 22 in the electrification. A voltage of the electrification of the polymer film 22 preferably can be constant in a range equal to or higher than −3 kV and equal to or lower than +3 kV. The static elimination bar 102 is positioned downstream from the cooler 48 in the embodiment, but is not limited to that according to the embodiment. Furthermore, a knurling roller 103 is positioned downstream from the static elimination bar 102, and used to knurl web edge portions of the polymer film 22 by embossing. The winder 49 includes a winding roller 110 and a press roller 111. The winding roller 110 winds the polymer film 22. The press roller 111 adjusts tension applied to the polymer film 22 in the course of the winding.

[Tension Drying]

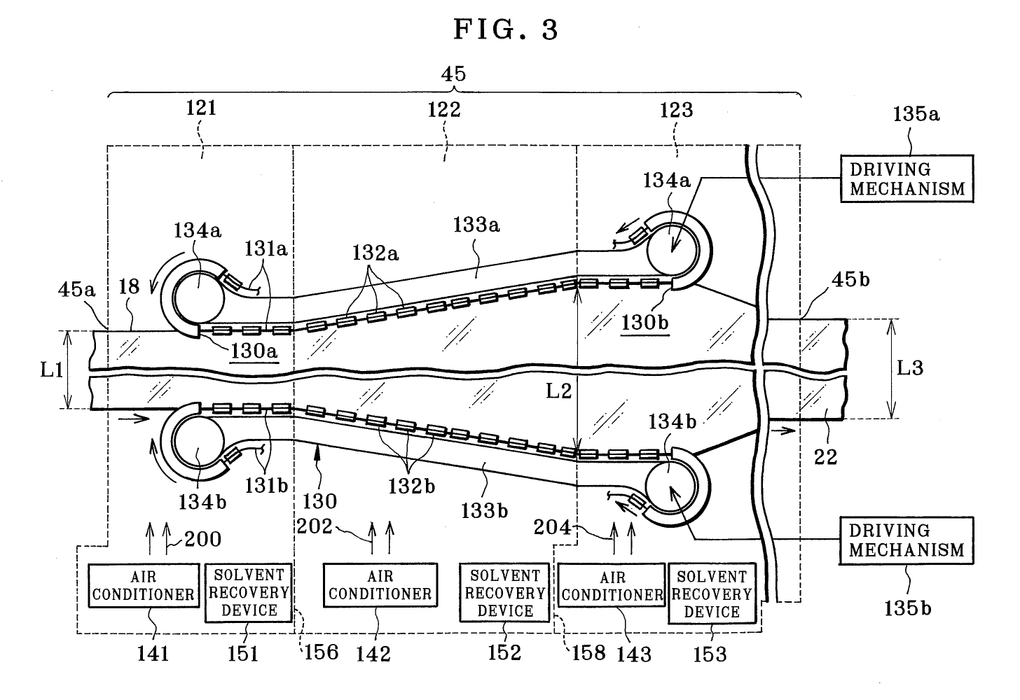

The tension drying chamber 45 is described now. In FIG. 3, there are three zones in the tension drying chamber 45, namely a first transport zone 121, a second transport zone 122 as first dryer, and a third transport zone 123 as second dryer. The preheating 31 by a preheater, the film stretching 32 and the stress relaxation 33 are carried out in respectively the transport zones 121-123. Note that a split structure of the temperature zones of the invention is not limited to the tension drying chamber 45.

A tentering machine 130 is contained in the tension drying chamber 45. The tentering machine 130 includes a pair of tenter chains 131a and 131b, tenter clip mechanisms 132a and 132b, tenter rails 133a and 133b, chain sprocket wheels 134a and 134b, and driving mechanisms 135a and 135b. The tenter chains 131a and 131b travel endlessly. The tenter clip mechanisms 132a and 132b are fastened on the tenter chains 131a and 131b at a regular interval, and clamp the web edges of the self-supporting cast film 18. The tenter rails 133a and 133b guide the travel of the tenter chains 131a and 131b. The chain sprocket wheels 134a and 134b are meshed with the tenter chains 131a and 131b. The driving mechanisms 135a and 135b drive the chain sprocket wheels 134a and 134b for rotation. The tenter clip mechanisms 132a and 132b are caused by the driving mechanisms 135a and 135b to move along the tenter rails 133a and 133b at a predetermined speed. Also, an upstream end 130a and a downstream end 130b of the tentering machine 130 are defined as passageway. The tentering machine 130 is so disposed in the tension drying chamber 45 to position the upstream end 130a in the first transport zone 121 and position the downstream end 130b in the third transport zone 123.

At the upstream end 130a, the tenter clip mechanisms 132a and 132b start clamping the web edges of the self-supporting cast film 18. The tenter clip mechanisms 132a and 132b travel to transport the self-supporting cast film 18 from the upstream end 130a of the tentering machine 130 toward the downstream end 130b. At the downstream end 130b, the web edges of the self-supporting cast film 18 are released from clamping of the tenter clip mechanisms 132a and 132b, to deliver the self-supporting cast film 18 to the web edge slitter 46 by means of rollers (not shown) disposed outside the downstream end 130b. The driving mechanisms 135a and 135b are disposed on a side of any one of the upstream and downstream ends 130a and 130b, and drive in such a manner that the chain sprocket wheels 134a and 134b operate in synchronism with one another. Note that the position of the driving mechanisms 135a and 135b is not limited.

Air conditioners 141-143 are disposed in respectively the transport zones 121-123. The air conditioners 141-143 keep the zone condition of the transport zones 121-123 adjusted in a predetermined zone condition, for example, inner temperature equal to or higher than 100 deg. C. and equal to or lower than 160 deg. C. Also, a circulator (not shown) is associated with each of the transport zones 121-123. The circulator circulates gas in the transport zones 121-123 to uniformize their zone condition. This is effective in conditioning a drying rate of the self-supporting cast film 18 passed through the transport zones 121-123 according to intention. The air conditioner 142 is for the first dryer, and the air conditioner 143 is for the second dryer.

Solvent recovery devices 151, 152 and 153 are disposed in the transport zones 121-123. The solvent recovery devices 151-153 aspirate gas in the transport zones 121-123, and withdraw and recover solvent from the transport zones 121-123. The gas or air after elimination of the solvent is delivered again into the transport zones 121-123. Also, the recovered solvent is preferably delivered to a dope preparing system, and reused. By use of the solvent recovery devices 151-153, density of the solvent contained in the gas in the transport zones 121-123 is adjusted in a range suitable for drying in the transport zones 121-123. This density is preferably equal to the saturation density of the solvent at the temperature equal to or higher than −10 deg. C. and equal to or lower than 0 deg. C.

The web edges of the self-supporting cast film 18 are clamped by the tenter clip mechanisms 132a and 132b in the first transport zone 121 at the upstream end 130a of the tentering machine 130. The self-supporting cast film 18 on the tenter clip mechanisms 132a and 132b proceeds from the first transport zone 121 to the third transport zone 123. During the transport, the self-supporting cast film 18 is processed in evaporation of solvent while the air conditioners 141-143 and the driving mechanisms 135a and 135b adjust the zone condition in a predetermined range in the transport zones 121-123, until a residual solvent amount comes down to a predetermined level. The web edges of the self-supporting cast film 18 are released from clamping of the tenter clip mechanisms 132a and 132b at the downstream end 130b of the tentering machine 130. The self-supporting cast film 18 is transported by rollers (not shown) while processed in evaporation of solvent in a prescribed condition, so that the polymer film 22 is moved to the web edge slitter 46.

The tenter rails 133a and 133b are so disposed to extend as to change their interval gradually in the transport zones 121-123 in a predetermined manner. Specifically, the tenter rails 133a and 133b are so disposed that a web width of the self-supporting cast film 18 is L1 on a borderline 156 between the first and second transport zones 121 and 122, and is L2 on a borderline 158 between the second and third transport zones 122 and 123. At a downstream end 45b of the tension drying chamber 45, the self-supporting cast film 18 has a web width L3. Note that U.S. Pat. No. 6,658,708 (corresponding to JP-A 2003-276082) discloses an example of an adjuster for adjusting a rail interval in the transport zones 121-123.

Thus, the self-supporting cast film 18 is processed in the stretching, stress relaxation and drying while passed through the tension drying chamber 45. Note that the stretching of the self-supporting cast film 18 is effected in a predetermined direction. The stress relaxation of the self-supporting cast film 18 is effected to relax stress remaining in the self-supporting cast film 18 upon the stretch. Note that the stress relaxation may be carried out while the web edges of the self-supporting cast film 18 are clamped by the tenter clip mechanisms 132a and 132b, or while the web edges are free from the tenter clip mechanisms 132a and 132b. The web width of the self-supporting cast film 18 in the stress relaxation may be equal to the width L2 after the stretch, or may be smaller than the width L2.

An example of the method of producing the polymer film 22 by use of the solution casting system 40 is hereinafter described.

The dope 11 is stirred and made uniform by rotation of the stirrer 56. It is possible in the stirring to add plasticizer or other additives to the dope 11. The dope 11 is delivered by the pump 58 to the filtration device 59, and is filtrated. The matte agent solution is delivered by the pump 66 to the conduit 67. The absorber is caused to flow in the conduit 72 by the pump 71. The matte agent solution in the conduit 67 is mixed with the absorber in the conduit 67. Those are stirred by the static mixer 74 to obtain an additive solution with uniformity. Then the additive solution is delivered through the conduit 67 and mixed with the dope 11 flowing in the conduit 61. Then the mixture is stirred by the static mixer 60 to obtain the dope 14 as composition with uniformity. A ratio of the dope 11, the matte agent solution and the absorber is not limited, but can be preferably in a range from 90:5:5 to 99:0.5:0.5 according to the unit of wt. %.

The dope 14 is cast by the casting die 41 on to the casting support belt 44. Tension which occurs in the casting support belt 44 in rotation of the drive rollers 42 and 43 for driving should be controlled and regulated in a range from 10⁴ N/m to 10⁵ N/m. A difference in the speed between the casting support belt 44 and the drive rollers 42 and 43 can be regulated at 0.01 m/min or less. A fluctuation in the speed of the casting support belt 44 can be kept at 0.5% or less. A zigzag movement of the casting support belt 44 in the belt width direction can be limited to 1.5 mm or less during one turn of the casting support belt 44. To control the zigzag movement, an edge detector (not shown) for detecting belt edges of the casting support belt 44 can be used. A position control unit (not shown) for the casting support belt 44 operates in consideration of the measured information of the detection, and effects feedback control to adjust the position of the casting support belt 44. Also, an under-die portion of the casting support belt 44 directly under the casting die 41 can be kept from moving beyond a range of 200 microns in a vertical direction while the drive rollers 42 and 43 rotate. It is preferable to use a temperature adjuster (not shown) to condition the inner temperature of the casting chamber 81 in a range from −10 to 57 deg. C. Solvent evaporated in the casting chamber 81 is condensed by the solvent condenser 82, recovered by the solvent recovery device 83, and refined and reused as a solvent for preparing dope.

The bead of the dope extends from the casting die 41 to the casting support belt 44. The cast film 16 is formed on the casting support belt 44. A preferable temperature level of the dope 14 being cast is in a range of −10 to 57 deg. C. In the course of casting, the decompressor 85 conditions the pressure in such a manner that the pressure on the rear side of the bead of the dope 14 or on the upstream side is lower than the atmospheric pressure. The pressure of the rear side of the bead is kept at a constant level which is equal to more than (AP −2,000 Pa) and equal to or less than (AP −10 Pa) where AP is pressure of the front side of the bead. A jacket (not shown) is preferably associated with the decompressor 85 for conditioning the inner temperature at a predetermined level. The temperature of the decompressor 85 is not limited, but can be preferably equal to or higher than the condensation point of the solvent. An aspiration device (not shown) is preferably connected to a slot edge portion of the casting die 41. An edge flow rate of the aspiration device can be preferably 1-100 liters per minute.

The cast film 16 is transported by the casting support belt 44, and receives evaporative gas from the gas flow ducts 87a-87c to evaporate and promote drying of the solvent. In the blow of the gas, the separation panel 87d suppresses changes in the surface form of the cast film 16. A range of the surface temperature is preferably from −20 to 40 deg. C.

When or after the cast film 16 comes to have the self-supporting property, the self-supporting cast film 18 is stripped from the casting support belt 44 by the stripping roller 89, and transported to the transition region 90. A residual solvent amount Z0 of the cast film 16 upon stripping is preferably more than 40 wt. % and less than 250 wt. % according to the dry base, and desirably more than 40 wt. % and less than 150 wt. %. Should the residual solvent amount Z0 be equal to or less than 40 wt. % according to the dry base, problems will occur as difficulty will arise in imparting retardation to the self-supporting cast film 18 or flattening the self-supporting cast film 18 in the subsequent stretching. Should the residual solvent amount Z0 be equal to or more than 250 wt. % according to the dry base, problems will occur as no sufficient strength will be obtained in view of stripping of the cast film 16 on the stripping roller 89. Note that the residual solvent amount herein is an amount expressed in the formula of [(x−y)/y]0.100 where x is a weight of the inspected sample of the cast film 16, the self-supporting cast film 18 or the polymer film 22 according to the dry base, and y is a weight of the sample in the totally dried state.

In the transition region 90, evaporative gas at a conditioned temperature, which is equal to or higher than 50 deg. C. and equal to or lower than 150 deg. C., is blown by the initial drying fan or blower 91 to the self-supporting cast film 18 to evaporate and promote drying. Plural rollers are used to transport the self-supporting cast film 18 toward the tension drying chamber 45. A first one of rollers in the transition region 90 positioned downstream is preferably driven to rotate at a higher speed than a second one of rollers positioned upstream, so as to impart draw tension to the self-supporting cast film 18.

The self-supporting cast film 18 when transported to the tension drying chamber 45 is clamped by the tenter clip mechanisms 132a and 132b at the upstream end 130a with the web edge portions, and is moved from the first transport zone 121 toward the third transport zone 123 along the tenter rails 133a and 133b. In the third transport zone 123, the web edges of the self-supporting cast film 18 are released from the tenter clip mechanisms 132a and 132b. The self-supporting cast film 18 is moved while dried in a predetermined condition, and transported to the film crusher 93 by rollers (not shown). Note that drying of the self-supporting cast film 18 in the tension drying chamber 45 will be described in detail.

The self-supporting cast film 18 is dried in the tension drying chamber 45 to the extent with a predetermined amount of residual solvent, so that the polymer film 22 is transported toward the web edge slitter 46. Web edges of the polymer film 22 are slitted by the web edge slitter 46. A cutter blower (not shown) or dust blower operates to blow film dust of the web edges toward the film crusher 93. The film crusher 93 forms film chips by grinding the film dust. This method is advantageous in its low cost as the chips can be reused for preparing dope. Note that the slitting step can be omitted from the solution casting process. However, it is preferable to slit the web edges of the polymer film or cast film in any one of points between steps from the casting step to the winding step.

The polymer film 22 after edge slitting is transported into the downstream dryer 47 and processed in evaporation of solvent further. An inner temperature of the downstream dryer 47 is not limited, but can be preferably in a range of 50-160 deg. C. The polymer film 22 is transported in contact with the transport rollers 100 in the downstream dryer 47, and is processed in evaporation of solvent. The evaporated content of the solvent is adsorbed and collected by the adsorption solvent recovery device 101 in the downstream dryer 47. Atmosphere after removal of the solvent content is caused again to flow into the downstream dryer 47 as evaporative gas. There are preferably plural zones defined in the downstream dryer 47. Temperature of evaporative gas for those zones is conditioned at different temperatures for evaporation of solvent. A pre-drying chamber (not shown) is also located between the web edge slitter 46 and the downstream dryer 47, for evaporation of solvent from the polymer film 22 in a preliminary manner. This is effective in suppressing changes in the shape of the polymer film 22 because abrupt rise in the film surface temperature is prevented.

The polymer film 22 is cooled down to the room temperature by the cooler 48. Furthermore, a fluidity adjusting chamber (not shown) may be disposed between the downstream dryer 47 and the cooler 48, to blow the polymer film 22 with air or gas of adjusted humidity and temperature. The polymer film 22 can be cooled after adjustment of fluidity of the polymer film 22. This is effective in flattening the polymer film 22 even if wrinkles have occurred on its surface.

A voltage of the electrification of the polymer film 22 during the transport is kept by the static elimination bar 102 in a predetermined range, for example, −3 kV to +3 kV. In FIG. 3, the static elimination bar 102 is positioned downstream from the cooler 48 in the embodiment, but is not limited to that as illustrated. Also, it is preferable to use the knurling roller 103 to knurl web edge portions of the polymer film 22 by embossing. A depth of a knurled pattern between the top and the bottom is preferably 1-200 microns.

Finally, the polymer film 22 is wound by the winding roller 110 in the winder 49. The press roller 111 can be preferably used to apply tension of the polymer film 22 at a suitable tension level while the polymer film 22 is wound. The tension in winding the polymer film 22 should preferably change gradually from the start to the end of the winding. A web length of the polymer film 22 can be equal to or more than 100 meters in the casting direction toward the winding roller 110. A web width of the polymer film 22 is preferably equal to or more than 600 mm, and desirably equal to or more than 1,400 mm and equal to or less than 1,800 mm. The feature of the invention is effective also if the width is over 1,800 mm, for example, equal to or less than 2,500 mm. The thickness of the polymer film may be very small according to the invention, for example a thickness equal to or more than 15 microns and equal to or less than 100 microns.

Steps of processing for the self-supporting cast film 18 in the tension drying chamber 45 are described next.

In FIG. 3, the self-supporting cast film 18 moved out of the transition region 90 is clamped by the tenter clip mechanisms 132a and 132b along the web edges at the upstream end 130a of the tentering machine 130 of the first transport zone 121. The tenter chains 131a and 131b travel to transport the self-supporting cast film 18 from the upstream end 130a toward the downstream end 130b. The web edges of the self-supporting cast film 18 are released from clamping of the tenter clip mechanisms 132a and 132b at the downstream end 130b. Rollers (not shown) transport the self-supporting cast film 18 to pass the third transport zone 123 after the release of the web edges. Consequently, the transport zones 121-123 are passed by the self-supporting cast film 18. The self-supporting cast film 18 becomes the polymer film 22 after the third transport zone 123, and is moved by rollers (not shown) to the web edge slitter 46.

The air conditioners 141-143 disposed in the transport zones 121-123 set the zone condition in a predetermined range. In the embodiment, temperature levels of the transport zones 121-123 are used for the zone condition.

[1st Zone]

The self-supporting cast film 18 in the first transport zone 121 is preheated in the preheating 31 by a preheater for the purpose of drying in regions including the second transport zone 122 and later. The residual solvent amount Z1 and temperature T1 of the self-supporting cast film 18 in the first transport zone 121 may be determined suitably for a residual solvent amount Z2 and temperature T2 which will be desired in steps succeeding to the first transport zone 121. For example, the temperature T1 is preferably equal to or higher than 100 deg. C. and equal to or lower than 160 deg. C. Should the temperature T1 be lower than 100 deg. C., the self-supporting cast film 18 cannot be preheated sufficiently. Should the temperature T1 be higher than 160 deg. C., abrupt shrinkage occurs in the self-supporting cast film 18 to cause wrinkles. The residual solvent amount Z1 is preferably equal to or more than 30 wt. % and equal to or less than 70 wt. %. Should the residual solvent amount Z1 be lower than 30 wt. %, time for drying on the casting support belt 44 will be considerably long to lower efficiency in the production. Should the residual solvent amount Z1 be more than 70 wt. %, the self-supporting cast film 18 is difficult to stretch in the succeeding stretching step, or it is highly difficult to impart the retardation to the self-supporting cast film 18 or smooth the film surface by operation in the stretching step.

[2nd Zone]

The self-supporting cast film 18 in the second transport zone 122 is processed in the film stretching 32 and the drying, for imparting retardation and smoothing a film surface. This is the first drying step of the invention. The temperature T2 of the self-supporting cast film 18 in the second transport zone 122 may be determined suitably for a condition of the manufacture. For example, the temperature T2 is preferably equal to or higher than 100 deg. C. and equal to or lower than 160 deg. C. Should the temperature T2 be lower than 100 deg. C., the self-supporting cast film 18 may be torn by stress in the stretch and will be difficult to transport. Should the temperature T2 be higher than 160 deg. C., it is impossible to orient the slow axis or smooth the film surface. Note that abrupt drying of the self-supporting cast film 18 in the atmosphere at a high temperature is unfavorable because unevenness in the resiliency will occur to create bowing on the self-supporting cast film 18.

Preferably, the residual solvent amount Z2 of the self-supporting cast film 18 in the second transport zone 122 is less than 25 wt. %. A difference between the residual solvent amounts Z0 and Z2 is preferably more than 20 wt. %. Should the residual solvent amount Z2 be 25 wt. % or more, or should the difference between the residual solvent amounts Z0 and Z2 be lower than 20 wt. %, it is impossible to orient the slow axis or smooth the film surface. This condition is effective in preventing bowing of the self-supporting cast film 18, and stretching and drying the same, so as to orient the slow axis of the self-supporting cast film 18 suitably and to smooth its surface.

[3rd Zone]

The self-supporting cast film 18 in the third transport zone 123 is processed in the stress relaxation 33 and the drying. This is the second drying step of the invention. The temperature T3 of the self-supporting cast film 18 in the third transport zone 123 satisfies the condition of:

0<T2−T3<50

Should (T2−T3) be equal to or less than zero, irregularity created in the stretching will remain in the self-supporting cast film 18. Should (T2−T3) be 50 or more, problems are likely to occur in that very high fluidity of polymer molecules in the self-supporting cast film 18 will create bowing, and that the self-supporting cast film 18 may be torn by stress in the stretch and will be difficult to transport. Note that a value of the difference (T2−T3) is preferably more than 3 and less than 30, and desirably more than 5 and less than 15. It is possible in the stress relaxation 33 to eliminate the irregularity created on the self-supporting cast film 18 in the stretching. The polymer film can be produced with high optical property.

Preferably, the residual solvent amount Z3 of the self-supporting cast film 18 in the third transport zone 123 is equal to or less than 5 wt. %. Should the residual solvent amount Z3 be more than 5 wt. %, the film surface of the self-supporting cast film 18 cannot be smoothed uniformly.

A stretch ratio R1 in the second transport zone 122 is preferably equal to or more than 5% and equal to or less than 60%. Should the stretch ratio R1 be less than 5%, it is impossible sufficiently to adjust the retardation of the self-supporting cast film 18 or smooth the film surface. Should the stretch ratio R1 be more than 60%, the self-supporting cast film 18 may be torn by stress in the stretch and will be difficult to transport. A stress relaxation ratio R2 in the third transport zone 123 is preferably equal to or more than 0.5% and equal to or less than 5%. Should the stress relaxation ratio R2 be less than 0.5%, wrinkles are likely to occur in the self-supporting cast film 18 due to its uneven shrinkage. Should the stress relaxation ratio R2 be more than 5%, failure in the transport occurs due to occurrence of looseness of the self-supporting cast film 18. Note that the stretch ratio is defined as R1=100×(L2−L1)/L1. The stress relaxation ratio is defined as R2=100×(L2−L3)/L3.

In the embodiment, it is possible in the tension drying 21 of FIG. 1 to prevent bowing or creation of unevenness on the polymer film during the film stretching or stress relaxation. Irregularity of the slow axis can be suppressed at the same time as the adjustment of the retardation and smoothing of the surface. The polymer film can have high optical performance as optical film. Also, the tension drying 21 of the invention can be used for the tension drying chamber 45 or the tentering machine 130 known in the field. It is possible to produce the polymer film 22 with high quality without great cost of investment for the manufacture.

It is possible to adjust the residual solvent amounts Z1-Z3 in the transport zones 121-123 by gas or air 200, 202 and 204 from the air conditioners 141-143 or by the transport speed of the self-supporting cast film 18. The transport speed of the self-supporting cast film 18 in the tension drying chamber 45 is preferably equal to or higher than 10 m/min and equal to or lower than 50 m/min. To keep the transport speed of the self-supporting cast film 18 in the above condition, speed of the tenter clip mechanisms 132a and 132b can be controlled by the driving mechanisms 135a and 135b. Also, the air conditioners 141-143 can apply the gas 200, 202 and 204 directly to the self-supporting cast film 18 in the zone condition adjusted according to the requirement in addition to conditioning of the air conditioners 141-143 for the gas in the transport zones 121-123. For drying the self-supporting cast film 18, the zone condition can include factors such as the gas speed and humidity of the gas 200, 202 and 204 delivered by the air conditioners 141-143. Also, a decompressor can be used to control pressure of the atmosphere in the transport zones 121-123 for passing the self-supporting cast film 18. Drying of the self-supporting cast film 18 can be controlled by a decompressor in combination with the air conditioners 141-143.

Residual solvent amounts Z1-Z3 in the transport zones 121-123 in the above embodiment are determined according to the predetermined condition of drying. The condition is obtained experimentally by adjusting various factors, which are the air condition, a transport speed of the self-supporting cast film 18, and a length of the tenter rails 133a and 133b. Also, measurement of residual solvent amount is according to measuring a weight per unit area of the self-supporting cast film 18 at the plural steps and an experimentally produced film.

Furthermore, polymer in the present invention may be a compound other than cellulose acylate or other cellulose ester, for example, polyolefin.

Various methods suggested in JP-A 2005-104148 are usable in combination with the casting of the invention, the methods including construction of the casting die, decompression chamber, support and other mechanical elements, multi casting, stripping, stretching, conditioning for drying in respective steps, polymer film handling, winding after eliminating a curl for flatness, solvent collection, and polymer film collection. Those can be used in the present invention.

A. Support of Metal for Solution Casting

Suggested in JP A 2000-84960; U.S. Pat. No. 2,336,310, U.S. Pat. No. 2,367,603, U.S. Pat. No. 2,492,078, U.S. Pat. No. 2,492,977, U.S. Pat. No. 2,492,978, U.S. Pat. No. 2,607,704, U.S. Pat. No. 2,739,069, U.S. Pat. No. 2,739,070, GB A 640731 (corresponding to U.S. Pat. No. 2,492,977), GB A 735892; JP B 45-4554, JP B 49-5614, JP A 60-176834, JP A 60-203430, and JP A 62-115035.

B. Multi Casting

Suggested in JP B 62-43846; JP A 61-158414, JP A 1-122419, JP B 60-27562, JP A 61-94724, JP A 61-947245, JP A 61-104813, JP A 61-158413, JP A 6-134933; JP A 56-162617; JP A 61-94724, JP A 61-94725, and JP A 11-198285.

C. Specific Methods of Casting of Cellulose Esters

Suggested in JP A 61-94724, JP A 61-148013, JP A 4-85011 (corresponding to U.S. Pat. No. 5,188,788), JP A 4-286611, JP A 5-185443, JP A 5-185445, JP A 6-278149, and JP A 8-207210.

D. Stretching

Suggested in JP A 62-115035, JP A 4-152125, JP A 4-284211, JP A 4-298310, and JP A 11-48271.

E. Specific Methods of Drying

Suggested in JP A 8-134336, JP A 8-259706, and JP A 8-325388.

F. Drying of Specific Controls of Heat

Suggested in JP A 04-001009 (corresponding to U.S. Pat. No. 5,152,947), JP A 62-046626, JP A 04-286611, and JP A 2000-002809.

G. Drying in Preventing Wrinkles

Suggested in JP A 11-123732, JP A 11-138568, and JP A 2000-176950.

[Performance and Measurement]

Curls, thickness and their measurement of the wound polymer film are suggested in known documents mentioned in JP-A 2005-104148. These can be used in the present invention.

No. 1. Curls and Thickness of the Polymer Film

Suggested in JP-A 2003-011143, JP-A 2002-214432, JP-A 2002-221620, JP-A 2003-055477, and JP-A 2003-014556.

No. 2. Thickness and its Measurement

Suggested in JP-A 2003-098345, JP-A 2000-009931, JP-A 2001-343528 (corresponding to U.S.P. 2002/192397), JP-A 2002-122735, and JP-A 2002-194107.

[Surface Treatment]

At least one of the two surfaces of the polymer film is preferably processed by surface processing. Examples of the surface processing include vacuum glow discharge processing, atmospheric pressure plasma discharge processing, ultraviolet radiation applying processing, corona discharge processing, flame processing, acid processing, alkali processing and the like.

[Functional Layers]

Also, at least one of the two surfaces of the cellulose acylate film can be coated with an undercoat. Various types of the undercoat can be used.

The obtained cellulose acylate film can preferably be coated with a functional material, to form a functional film. Examples of functional layers include an antistatic layer, hard resin layer, anti reflection layer, attachment facilitating layer, anti-glare layer, optical compensation layer and the like.

At least one surface active agent can be preferably included in the functional layers in a range of 0.1-1,000 mg per sq. meter. At least one smoothing agent can be included in the functional layers in a range of 0.1-1,000 mg per sq. meter. At least one matte agent can be included in the functional layers in a range of 0.1-1,000 mg per sq. meter. Further, at least one antistatic agent can be included in the functional layers in a range of 1-1,000 mg per sq. meter. Methods of adding the surface processed functional layers to the cellulose acylate film, and their various conditions are according to techniques suggested in JP-A 2005-104148. Those can be used in the present invention.

I. Plasma Processing in General

Suggested in JP A 6-123062 (corresponding to EP A 592979), JP A 11-5857, and JP A 11-293011.

II. Specific Methods of Plasma Processing

Suggested in JP A 2003-161807, JP A 2003-166063 (corresponding to U.S. Pat. No. 6,849,306), JP A 2003-171770, JP A 2003-183836, JP A 2003-201568, and JP A 2003-201570.

III. Glow Discharge Processing

Suggested in U.S. Pat. No. 3,462,335, U.S. Pat. No. 3,761,299, U.S. Pat. No. 4,072,769, GB A 891469; JP A 59-056430, and JP B 60-16614 (corresponding to GB A 1579002).

IV. Ultraviolet Processing

Suggested in JP B 43-2603, JP B 43-2604, and JP B 45-3828 (corresponding to GB A 1149812).

V. Corona Discharge Processing

Suggested in JP B 39-12838, JP A 47-19824 (corresponding to U.S. Pat. No. 3,849,166), JP A 48-28067 (corresponding to U.S. Pat. No. 3,755,683), and JP A 52-42114 (corresponding to U.S. Pat. No. 4,135,932).

VI. Matte Agents for Undercoats

Suggested in U.S. Pat. No. 4,142,894, and U.S. Pat. No. 4,396,706.

VII. Lubricants

Suggested in JP B 53-292, U.S. Pat. No. 3,933,516, U.S. Pat. No. 4,275,146; JP B 58-33541, GB A 927446 (corresponding to U.S. Pat. No. 3,121,060); JP A 55-126238, JP A 58-90633; JP A 58-50534; and European Patent Application 90108115 (corresponding to U.S. Pat. No. 5,063,147).

VIII. Polyorganosiloxanes as Lubricants

Suggested in JP B 53-292, JP B 55-49294, and JP A 60-140341.

IX. Antistatic Agents of Ionic Macromolecular Types

Suggested in JP B 49-23827, JP B 49-23828, JP B 47-28937; JP B 55-734, JP A 50-54672, JP B 59-14735, JP B 57-18175, JP B 57-18176, JP B 57-56059; JP B 53-13223, JP B 57-15376, JP B 53-45231, JP B 55-145783, JP B 55-65950, JP B 55-67746, JP B 57-11342, JP B 57-19735, JP B 58-56858, JP A 61-27853, and JP B 62-9346.

X. Polymer Films Coatable with Hard Coat Layers

Suggested in JP A 6-123806, JP A 9-113728, and JP A 9-203810.

XI. Photo Polymerizable Compounds

Suggested in JP A 50-151996, JP A 50-158680; JP A 50-151997 (corresponding to U.S. Pat. No. 4,058,401), JP A 52-30899 (corresponding to U.S. Pat. No. 4,256,828), JP A 55-125105; JP A 56-8428 (corresponding to U.S. Pat. No. 4,299,938), JP A 56-55420 (corresponding to U.S. Pat. No. 4,374,066), JP A 56-149402 (corresponding to U.S. Pat. No. 4,339,567), JP A 57-192429 (corresponding to U.S. Pat. No. 4,387,216); JP B 49-17040; and U.S. Pat. No. 4,139,655.

XII. Coatings for Preventing Reflection

Suggested in JP A 7-126552, JP A 7-188582, JP A 8-48935, JP A 8-100136, JP A 9-220791, and JP A 9-272169.

[Uses]

The above-described cellulose ester film is useful particularly as a polarizer protecting film. A panel shaped polarizer is obtained by attachment of cellulose ester films on a polarizer element. Two panel shaped polarizers are attached to a liquid crystal layers to create a liquid crystal display panel. Note that the order of the layers or films may be modified. Various examples of liquid crystal display panels are known and suggested in JP-A 2005-104148, including TN type, STN type, VA type, OCB type, reflection type and the like. Any of those can be used in the present invention. The prior art also suggests cellulose ester film including an optical anisotropic layer, and cellulose ester film with an anti-reflection property or antiglare property. Also, the use of biaxial cellulose ester film as optical compensation film is disclosed with suitable optical characteristics. Furthermore, cellulose ester film can be used both for the optical compensation film and the polarizer protecting film. The features can be combined with the present invention. Details of those are according to various suggested techniques mentioned in JP-A 2005-104148.

No. 1. Cellulose Ester Protective Films for Polarizers

Suggested in JP A 10-095861, JP A 10-095862, and JP A 09-113727.

No. 2. Uses of Cellulose Ester Films as High Performance Optical Elements

Suggested in JP A 2000-284124, JP A 2000-284123, and JP A 11-254466.

No. 3. Production of Cellulose Ester Films as High Performance Optical Elements

Suggested in JP A 2000-131523, JP A 06-130226, JP A 06-235819, JP A 2000-212298 (corresponding to U.S. Pat. No. 6,731,357), and JP A 2000-204173.

No. 4. Optical Compensation Sheets

Suggested in JP A 3-9325 (corresponding to U.S. Pat. No. 5,132,147), JP A 6-148429, JP A 8-50206 (corresponding to U.S. Pat. No. 5,583,679), and JP A 9-26572 (corresponding to U.S. Pat. No. 5,855,971).

No. 5. TN Type of LCD Panels

Suggested in JP A 3-9325 (corresponding to U.S. Pat. No. 5,132,147), JP A 6-148429, JP A 8-50206 (corresponding to U.S. Pat. No. 5,583,679), and JP A 9-26572 (corresponding to U.S. Pat. No. 5,855,971).

No. 6. Reflection Type of LCD Panels

Suggested in JP A 10-123478, WO 9848320 (corresponding to U.S. Pat. No. 6,791,640), JP B 3022477 (corresponding to U.S. Pat. No. 6,433,845); and WO 00-65384 (corresponding to EP A 1182470).

No. 7. Discotic Compounds as Coating Cellulose Ester Films

Suggested in JP A 7-267902, JP A 7-281028 (corresponding to U.S. Pat. No. 5,518,783), and JP A 7-306317.

No. 8. Characteristics of Optical Compensation Sheets

Suggested in JP A 8-5837, JP A 7-191217, JP A 8-50206, and JP A 7-281028.

No. 9. Production of Optical Compensation Sheets

Suggested in JP A 9-73081, JP A 8-160431, and JP A 9-73016.

No. 10. Use of Cellulose Ester Films in LCD Panels

Suggested in JP A 8-95034, JP A 9-197397, and JP A 11-316378.

No. 11. LCD Elements of Guest-Host Reflection Types

Suggested in JP A 6-222350, JP A 8-36174, JP A 10-268300, JP A 10-292175, JP A 10-293301, JP A 10-311976, JP A 10-319442, JP A 10-325953, JP A 10-333138, and JP A 11-38410.

No. 12. Coating Methods

Suggested in U.S. Pat. No. 2,681,294;U.S. Pat. No. 2,761,791, U.S. Pat. No. 2,941,898, U.S. Pat. No. 3,508,947, and U.S. Pat. No. 3,526,528.

No. 13. Constructions of Overlaying Coatings

Suggested in JP A 8-122504, JP A 8-110401, JP A 10-300902 (corresponding to U.S. Pat. No. 6,207,263), JP A 2000-111706; JP A 10-206603 (corresponding to U.S. Pat. No. 6,207,263), and JP A 2002-243906.

No. 14. High Refractive Index Layer and Middle Refractive Index Layer

Suggested in JP A 11-295503, JP A 11-153703 (corresponding to U.S. Pat. No. 6,210,858), JP A 2000-9908, JP A 2001-310432, JP A 2001-166104 (corresponding to U.S. Pat. No. 6,791,649), U.S. Pat. No. 6,210,858, JP A 2002-277609 (corresponding to U.S. Pat. No. 6,949,284), JP A 2000-47004, JP A 2001-315242, JP A 2001-31871, JP A 2001-296401, and JP A 2001-293818.

No. 15. Low Refractive Index Layer

Suggested in JP A 9-222503, JP A 11-38202, JP A 2001-40284, JP A 2000-284102, JP A 11-258403, JP A 58-142958, JP A 58-147483, JP A 58-147484, JP A 9-157582 (corresponding to U.S. Pat. No. 6,183,872), JP A 11-106704 (corresponding to U.S. Pat. No. 6,129,980), JP A 2000-117902, JP A 2001-48590 (corresponding to U.S. Pat. No. 6,511,721), and JP A 2002-53804 (corresponding to U.S. Pat. No. 6,558,804).

No. 16. Hard Coat Layer

Suggested in JP A 2002-144913, JP A 2000-9908, and WO 00/46617 (corresponding to U.S. Pat. No. 7,063,872).

No. 17. Front Scattering Layer

Suggested in JP A 11-38208, JP A 2000-199809 (corresponding to U.S. Pat. No. 6,348,960), and JP A 2002-107512.

No. 18. Antiglare Characteristic

Suggested in Japanese Patent Application 2000-271878 (corresponding to JP A 2002-082207); JP A 2001-281410, Japanese Patent Application 2000-95893 (corresponding to U.S. Pat. No. 6,778,240), JP A 2001-100004 (corresponding to U.S. Pat. No. 6,693,746), JP A 2001-281407; JP A 63-278839, JP A 11-183710, and JP A 2000-275401.

No. 19. Dichroic Compounds

Suggested in JP A 1-161202, JP A 1-172906, JP A 1-172907, JP A 1-183602, JP A 1-248105, JP A 1-265205, and JP A 7-261024 (corresponding to U.S. Pat. No. 5,706,131).

No. 20. Various Devices and Films for Optics

Suggested in JP A 5-19115, JP A 5-119216, JP A 5-162261, JP A 5-182518, JP A 5-196819, JP A 5-264811, JP A 5-281411, JP A 5-281417, JP A 5-281537, JP A 5-288921, JP A 5-288923, JP A 5-311119, JP A 5-339395, JP A 5-40204, JP A 5-45512, JP A 6-109922, JP A 6-123805, JP A 6-160626, JP A 6-214107, JP A 6-214108, JP A 6-214109, JP A 6-222209, JP A 6-222353, JP A 6-234175, JP A 6-235810, JP A 6-241397, JP A 6-258520, JP A 6-264030, JP A 6-305270, JP A 6-331826, JP A 6-347641, JP A 6-75110, JP A 6-75111, JP A 6-82779, JP A 6-93133, JP A 7-104126, JP A 7-134212, JP A 7-181322, JP A 7-188383, JP A 7-230086, JP A 7-290652, JP A 7-294903, JP A 7-294904, JP A 7-294905, JP A 7-325219, JP A 7-56014, JP A 7-56017, JP A 7-92321, JP A 8-122525, JP A 8-146220, JP A 8-171016, JP A 8-188661, JP A 8-21999, JP A 8-240712, JP A 8-25575, JP A 8-286179, JP A 8-292322, JP A 8-297211, JP A 8-304624, JP A 8-313881, JP A 8-43812, JP A 8-62419, JP A 8-62422, JP A 8-76112, JP A 8-94834, JP A 9-137143, JP A 9-197127, JP A 9-251110, JP A 9-258023, JP A 9-269413, JP A 9-269414, JP A 9-281483, JP A 9-288212, JP A 9-288213, JP A 9-292525, JP A 9-292526, JP A 9-294959, JP A 9-318817, JP A 9-80233, JP A 9-99515, JP A 10-10320, JP A 10-104428, JP A 10-111403, JP A 10-111507, JP A 10-123302, JP A 10-123322, JP A 10-123323, JP A 10-176118, JP A 10-186133, JP A 10-264322, JP A 10-268133, JP A 10-268134, JP A 10-319408, JP A 10-332933, JP A 10-39137, JP A 10-39140, JP A 10-68821, JP A 10-68824, JP A 10-90517, JP A 11-116903, JP A 11-181131, JP A 11-211901, JP A 11-211914, JP A 11-242119, JP A 11-246693, JP A 11-246694, JP A 11-256117, JP A 11-258425, JP A 11-263861, JP A 11-287902, JP A 11-295525, JP A 11-295527, JP A 11-302423, JP A 11-309830, JP A 11-323552, JP A 11-335641, JP A 11-344700, JP A 11-349947, JP A 11-95011, JP A 11-95030, JP A 11-95208, JP A 2000-109780, JP A 2000-110070, JP A 2000-119657, JP A 2000-141556, JP A 2000-147208, JP A 2000-17099, JP A 2000-171603, JP A 2000-171618, JP A 2000-180615, JP A 2000-187102, JP A 2000-187106, JP A 2000-191819, JP A 2000-191821, JP A 2000-193804, JP A 2000-204189, JP A 2000-206306, JP A 2000-214323, JP A 2000-214329, JP A 2000-230159, JP A 2000-235107, JP A 2000-241626, JP A 2000-250038, JP A 2000-267095, JP A 2000-284122, JP A 2000-292780, JP A 2000-292781, JP A 2000-304927, JP A 2000-304928, JP A 2000-304929, JP A 2000-309195, JP A 2000-309196, JP A 2000-309198, JP A 2000-309642, JP A 2000-310704, JP A 2000-310708, JP A 2000-310709, JP A 2000-310710, JP A 2000-310711, JP A 2000-310712, JP A 2000-310713, JP A 2000-310714, JP A 2000-310715, JP A 2000-310716, JP A 2000-310717, JP A 2000-321560, JP A 2000-321567, JP A 2000-329936, JP A 2000-329941, JP A 2000-338309, JP A 2000-338329, JP A 2000-344905, JP A 2000-347016, JP A 2000-347017, JP A 2000-347026, JP A 2000-347027, JP A 2000-347029, JP A 2000-347030, JP A 2000-347031, JP A 2000-347032, JP A 2000-347033, JP A 2000-347034, JP A 2000-347035, JP A 2000-347037, JP A 2000-347038, JP A 2000-86989, and JP A 2000-98392; and

JP A 2001-4819, JP A 2001-4829, JP A 2001-4830, JP A 2001-4831, JP A 2001-4832, JP A 2001-4834, JP A 2001-4835, JP A 2001-4836, JP A 2001-4838, JP A 2001-4839, JP A 2001-100012, JP A 2001-108805, JP A 2001-108806, JP A 2001-133627, JP A 2001-133628, JP A 2001-142062, JP A 2001-142072, JP A 2001-174630, JP A 2001-174634, JP A 2001-174637, JP A 2001-179902, JP A 2001-183526, JP A 2001-183653, JP A 2001-188103, JP A 2001-188124, JP A 2001-188125, JP A 2001-188225, JP A 2001-188231, JP A 2001-194505, JP A 2001-228311, JP A 2001-228333, JP A 2001-242461, JP A 2001-242546, JP A 2001-247834, JP A 2001-26061, JP A 2001-264517, JP A 2001-272535, JP A 2001-278924, JP A 2001-2797, JP A 2001-287308, JP A 2001-305345, JP A 2001-311823, JP A 2001-311827, JP A 2001-350005, JP A 2001-356207, JP A 2001-356213, JP A 2001-42122, JP A 2001-42323, JP A 2001-42325, JP A 2001-51118, JP A 2001-51119, JP A 2001-51120, JP A 2001-51273, JP A 2001-51274, JP A 2001-55573, JP A 2001-66431, JP A 2001-66597, JP A 2001-74920, JP A 2001-81469, JP A 2001-83329, JP A 2001-83515, JP A 2001-91719, JP A 2002-162628, JP A 2002-169024 (corresponding to U.S. Pat. No. 6,606,136), JP A 2002-189421, JP A 2002-201367 (corresponding to U.S. Pat. No. 6,093,133), JP A 2002-20410 (corresponding to U.S. Pat. No. 6,974,608), JP A 2002-258046, JP A 2002-275391, JP A 2002-294174, JP A 2002-311214 (corresponding to U.S. Pat. No. 6,841,237), JP A 2002-311246 (corresponding to U.S. Pat. No. 6,965,473), JP A 2002-328233, JP A 2002-338703, JP A 2002-363266 (corresponding to U.S. Pat. No. 6,894,141), JP A 2002-365164, JP A 2002-370303, JP A 2002-40209 (corresponding to U.S. Pat. No. 6,649,271), JP A 2002-48917 (corresponding to U.S. Pat. No. 6,628,369), JP A 2002-6109 (corresponding to U.S. Pat. No. 6,505,942), JP A 2002-71950, JP A 2002-82222, JP A 2002-90528, JP A 2003-105540 (corresponding to U.S. Pat. No. 6,689,479), JP A 2003-114331, JP A 2003-131036 (corresponding to U.S.P. 2003/031848), JP A 2003-139952, JP A 2003-153353, JP A 2003-172819, JP A 2003-35819, JP A 2003-43252 (corresponding to U.S. Pat. No. 6,552,145), JP A 2003-50318 (corresponding to U.S. Pat. No. 7,136,225), and JP A 2003-96066 (corresponding to U.S. Pat. No. 7,087,273).

It is possible in the invention to form cellulose triacetate (TAC) film having high optical performance. The TAC film can be used as a base film for a polarizer protecting film or photosensitive material. Also, the TAC film can be used as an optical compensation film for use with a liquid crystal display panel in a television set to compensate for dependency upon the viewing angle. Also, the TAC film can be effectively used as an element which is both of a panel shaped polarizer and a protecting film simultaneously. A mode of the liquid crystal may be not only the TN mode but any one of the IPS mode, OCB mode and VA mode. Panel shaped polarizers can be constructed by use of a polarizer protecting film.

### Example 1

Experiments were conducted for Examples 1-14 and Comparative examples 1-10. Among those, Example 1 is described in detail. For Examples 2-14 and Comparative examples, only differences from Example 1 will be described specifically.

At first, Example 1 is described. The following is content of components for preparing the polymer solution or dope for use in the film production.

[Materials for dope]

| | | |
|---|---|---|
| Cellulose triacetate | 100 | parts by weight |
| Dichloromethane | 441 | parts by weight |
| Methanol | 66 | parts by weight |
| Plasticizer A | 7 | parts by weight |
| Plasticizer B | 3 | parts by weight |
| Retardation control agent | 7 | parts by weight |
| Fine particles | 0.03 | part by weight |

In the list, the cellulose triacetate was powder particles having the following specifics—substitution degree: 2.81, average acetylation degree: 60.2%, viscosity average degree of polymerization (DP): 306, water content: 0.2 wt. %, viscosity of 6 wt. % dichloromethane solution: 315 mPa·s, average particle diameter of powder particles: 1.5 mm, standard deviation of the particle diameter of powder particles: 0.5 mm. The plasticizer A was triphenylphosphate. The plasticizer B was biphenyl diphenyl phosphate. The retardation control agent was Heterocyclic compound 1 of the above-indicated formula. The fine particles were particles of silicon dioxide with a particle diameter of 15 nm, and Mohs hardness number of approx. 7.

[Cellulose Triacetate]

In the cellulose triacetate (TAC), an amount of the residual acetic acid was 0.1 wt. % or less. The TAC contained 58 ppm of Ca, 42 ppm of Mg, 0.5 ppm of Fe, 40 ppm of the free acid content of acetic acid, and 15 ppm of sulfate ion. In the TAC, a degree of acetyl substitution of the 6-position was 0.91. A ratio of the acetyl group of the substitution of the 6-position relative to all of the acyl groups was 32.5%. In the TAC, an extracted amount of acetone was 8 wt. %. A ratio of the weight average molecular weight to the number average molecular weight was 2.5. The TAC had yellow index of 1.7, haze of 0.08, and transparency of 93.5%. The glass transition temperature Tg measured by the DSC (Differential Scanning Calorimetry) was 160 deg. C. An amount of heat of crystallization was 6.4 J per gram. Raw material of cellulose for the TAC was cotton. The TAC herein will be referred to as cotton-derived TAC.

### Example 1

### Step 1. Preparation of Dope

The solvent tank or reservoir of stainless steel was 4,000 liters large, and mixed delivered solvents by stirring to obtain mixed solvent. Any one of the delivered solvents had the water content of 0.5 wt. % or less. Then the hopper added TAC flake or powder gradually to the mixed solvent. The inside of the dissolving tank or reservoir was stirred by use of a dissolver stirrer and an anchor stirrer for 30 minutes, the dissolver stirrer stirring at 5 m/sec as a peripheral speed, the anchor stirrer stirring at 1 m/sec as a peripheral speed. The temperature was 25 deg. C. at the start of the dispersion, and 48 deg. C. at the final step of the dispersion. A solution of additives from the additive tank was added to the mixed solvent, to prepare the composition with a weight of 2,000 kg. After the dispersion, the stirring at the high speed was stopped. The anchor stirrer stirred further for 100 minutes at the peripheral speed of 0.5 m/sec, to obtain the swollen liquid by swelling the TAC flake. Before the end of the swelling, the inside of the dissolving tank was pressurized with gaseous nitrogen at 0.12 MPa. The oxygen density was 2 vol. % or less, the dissolving tank being kept safe in view of an explosion-proof structure. A water content in the dope was 0.3 wt. %.

### Example 1

### Step 2. Dissolving and Filtration

The swollen liquid was delivered through the conduit with a jacket from the dissolving tank or reservoir. The conduit with the jacket heated the swollen liquid up to 50 deg. C., and further heated the swollen liquid to 90 deg. C. during application of pressure of 2 MPa, for complete dissolution. Time in the course of heating was 15 minutes. Then the swollen liquid was cooled by the temperature adjuster down to 36 deg. C., and caused to pass the filtration device having a filter with a nominal pore diameter of 8 microns, to obtain dope (unconcentrated dope). Pressure on the primary side of the filtration was 1.5 MPa. Pressure on the secondary side of the filtration was 1.2 MPa. Elements of metal subjected to high temperature were formed from alloy with a trade name of Hastelloy, the elements including the filter, housing and conduits. The metal had high resistance to corrosion. Those elements were provided with a jacket for flow of heat exchange medium for controlling heat.

### Example 1

### Step 3. Condensation, Filtration, Defoaming and Addition of Agents

The dope before the concentration was flashed in the flash evaporator or flash device conditioned at 80 deg. C. with an atmospheric pressure, and condensed by a condenser. The amount of the solid content of the flashed dope was 21.8 wt. %. The solvent was liquefied, collected and separated by the solvent recovery device. The collected solvent was adjusted for preparation by the refiner for reuse. After the refinement in the refiner, the solvent was sent to the solvent tank or reservoir. Distillation and dehydration were effected in the solvent recovery device and the refiner. A flash tank in the flash evaporator or flash device included an anchor stirrer (not shown) at the center. The anchor stirrer stirred the dope for eliminating bubbles by rotations at the peripheral speed of 0.5 m/sec. Temperature of the dope in the flash tank was 25 deg. C. Average time of stay of the dope in the flash tank was 50 minutes. Shear viscosity of the dope measured at 25 deg. C. was 450 Pa·s at the shear rate of 10 (/second).

Then bubbles were eliminated from the dope by ultrasonic waves of low energy for defoaming. The pump was used for the dope to flow to the filtration device in a pressurized state of 1.5 MPa. In the filtration device, the dope was passed through a sintered fiber/metal filter with a nominal minimum pore diameter of 10 microns, and then through a sintered fiber filter with a nominal minimum pore diameter of 10 microns. For those filters, the primary pressure was respectively 1.5 and 1.2 MPa, the secondary pressure being respectively 1.0 and 0.8 MPa. The filtrated dope was conditioned at the temperature of 36 deg. C., and stored in the storage reservoir or stock tank 39 of stainless steel and 2,000 liters large. The storage reservoir or stock tank 39 contained the stirrer 56 as anchor stirrer at its center, and stirred the dope 11 incessantly at a peripheral speed of 0.3 m/sec. As a result, no problem of corrosion or the like occurred in portions of device elements contacting the dope in preparing the dope 11 from that before the concentration.

### Example 1

### Step 4. Delivery, Addition, Casting and Decompression

The solution casting system 40 of FIG. 2 was used to produce the polymer film 22. The dope in the storing tank or reservoir 39 was dispensed by the pump 58 of high precision type to the filtration device 59. The pump 58 was a gear pump, included an inverter motor, had a structure for increasing the pressure of an upstream side of the pump 58, and carried out feedback control to set the pressure of the upstream side at 0.8 MPa in delivery of the dope. The pump 58 had a volume efficiency of 99.2%, and a ratio of fluctuation of 0.5% or less in the discharged amount. A pressure of discharge of the pump 58 was 1.5 MPa. The dope passed in the filtration device 59 was sent to the casting die 41.

The casting die 41 was 1.8 meters wide. The dope was cast by controlling its flow rate at the casting die 41 so as to obtain the polymer film 22 with a thickness in a dried state of 80 microns. A casting dope width of the casting die 41 was 1,700 mm. A casting speed was 100 m/min. A jacket (not shown) was provided in combination with the casting die 41, for maintaining the heat exchange medium at the temperature 36 deg. C. at an upstream end of the jacket, for setting the dope at 36 deg. C.

Any one of the casting die 41 and the conduits were kept warm at 36 deg. C. in the course of casting to form film. The casting die 41 was a coat hanger type, had thickness adjusting die bolts or heat bolts arranged at a pitch of 20 mm. The die bolts were adapted to automatic adjustment of the thickness. The die bolts were constructed to set up a profile according to a flow amount of the high-precision gear pump 58 by a stored program, and also were capable of feedback control according to an adjusting program based on the profile of an infrared thickness meter (not shown) installed in the solution casting system 40. A difference in the thickness between any two points which were on the polymer film and distant to one another at 50 mm, except for the web edges of 20 mm, was equal to or less than 1 micron. The greatest difference between minimum values of the thickness in the width direction was set equal to or less than 3 microns per meter. Precision in the thickness was so determined that an average error in the total film thickness was set equal to or less than 1.5%.

The decompressor 85 was connected with the casting die 41 for negative pressure on a side upstream in relation to travel of the casting support belt 44. The decompressor 85 was structured to create a difference in the pressure in a range of 1-5,000 Pa between two sides defined by the casting bead, and was adjustable according to the casting speed. The difference in pressure was determined so as to set a length of the casting bead at 20-50 mm. Also, a mechanism of the decompressor 85 was structured to set the chamber temperature higher than a condensation temperature of gaseous substances present around the position of casting. A labyrinth packing (not shown) was disposed respectively in front of and behind the bead at the die slot. Openings were formed at ends of the die slot of the casting die. An edge suction device (not shown) was secured to the casting die 41, for eliminating irregularity in side edges of the casting bead.

### Example 1, Step 5. Casting Die

Preferable materials of the casting die 41 were stainless steel of a type of precipitation hardening. The material had a coefficient of thermal expansion of 2×10⁻⁵ (/deg. C.) or less. A corrosion resistance of the material was equal to that of SUS 316 steel according to forced corrosion test in electrolytic aqueous solution. Also, the material of the casting die 41 had the corrosion resistance sufficient for prevention of pitting on the gas-liquid interface even after dipping in a liquid mixture of dichloromethane, methanol and water for three (3) months. Surfaces of the casting die 41 to contact the liquid were formed with precision to have a surface roughness of 1 micron or less, and a degree of straightness of 1 micron per meter or less in any direction. A clearance of the die slot was set at 1.5 mm by adjustment. Preferable corner portions at the end of the die lip to contact the liquid were shaped so as to set a radius of curvature R at 50 microns or less in the whole width of the slot. A preferable shear rate inside the die was in a range of 1-5,000 (1/sec). A hardened layer or case was formed on the end of the slot lip of the casting die 41, for example, a WC (tungsten carbide) coating applied by a thermal spray process.

Also, a mixed solvent A was prepared by mixture of 86.5 parts by weight of dichloromethane, 13 parts by weight of methanol, and 0.5 part by weight of n-butanol.

The mixed solvent A for imparting solubility to dopes was delivered at a rate of 0.5 ml/min at each web edge to a gas-liquid interface between an end of the bead and the die slot of the casting die 41, for the purpose of locally preventing drying and solidification of the dope at the slot ends. A pump for delivering the mixed solvent A had a fluctuation ratio of 5% or lower. The decompressor 85 decompressed for providing 150 Pa of a pressure difference by which the pressure on the bead was lower on an upstream side than on a downstream side relative to the travel of the casting support belt 44. The jacket (not shown) was connected for keeping the decompressor 85 at a constant temperature. A heat exchange medium conditioned at 35 deg. C. was caused to flow through the jacket. The edge suction device for suction of web edges was adjustable in a range of a gas amount of 1-100 liters per minute, and was adjusted according to the example in a range of 30-40 liters per minute in operation.

### Example 1

### Step 6. Casting Support Belt of Metal

The casting support belt 44 was an endless belt of stainless steel, and was 2.1 meters wide and 70 meters long. A thickness of the casting support belt 44 was 1.5 mm. A surface roughness of the casting support belt 44 was 0.05 micron or less owing to polishing the belt surface. The material of the casting support belt 44 was SUS 316, and had sufficient strength and resistance to corrosion. Irregularity of the thickness of the casting support belt 44 was 0.5% or less. The casting support belt 44 was driven to turn by the drive rollers 42 and 43. Tension exerted in the casting support belt 44 in rotation of the drive rollers 42 and 43 for driving was controlled and regulated at a level of 1.5×10⁵ N per sq. meter. A difference in the speed between the casting support belt 44 and the drive rollers 42 and 43 was regulated at 0.01 m/min or less. A fluctuation in the speed of the casting support belt 44 was 0.5% or less. A zigzag movement of the casting support belt 44 in the belt width direction was limited to 1.5 mm or less during one turn of the casting support belt 44 by monitoring belt edges. An under-die portion of the casting support belt 44 directly under the casting die 41 was kept from moving beyond a range of 200 microns in a vertical direction. A gas pressure regulating structure (not shown) was disposed in the casting chamber 81 where the casting support belt 44 was contained. The dope was cast on the casting support belt 44 by the casting die 41.

A flow conduit was formed through the drive rollers 42 and 43, and caused a heat exchange medium to keep the casting support belt 44 at a target temperature by flow of the heat exchange medium at a prescribed temperature. Heat exchange medium of 5 deg. C. was introduced to the drive roller 42 on the side of the casting die 41. Heat exchange medium of 40 deg. C. was introduced to the drive roller 43 on the opposite side. Shortly before the casting, a surface temperature at the center of the casting support belt 44 was 15 deg. C. A difference of the end temperatures at the end of the casting support belt 44 was 6 deg. C. or less. It was preferable to minimize the surface defects of the casting support belt 44. Specifically, an amount of a pinhole in a size of 30 microns or more was zero. An amount of a pinhole in a size equal to or more than 10 microns and less than 30 microns was one (1) or less per sq. meter. An amount of a pinhole in a size less than 10 microns was two (2) or less per sq. meter.

### Example 1

### Step 7. Casting and Drying

The temperature of the casting chamber 81 was conditioned at 35 deg. C. by a temperature adjuster (not shown). The cast film 16 formed from the dope cast on the casting support belt 44 was dried by evaporative gas initially flowing in parallel. An overall heat transfer coefficient from the evaporative gas to the cast film 16 was 24 kcal/m².hr. (deg. C.). The gas flow duct 87a, positioned higher than the casting support belt 44 at its upstream portion, blew evaporative gas at 135 deg. C. The gas flow duct 87b, positioned higher than the casting support belt 44 at its downstream portion, blew evaporative gas at 140 deg. C. The gas flow duct 87c, positioned under the casting support belt 44, blew evaporative gas at 65 deg. C. The saturation temperature of the evaporative gas of each of the flows was approximately −8 deg. C. Oxygen density at the casting support belt 44 in the dry atmosphere was kept at 5 vol. %. Also, gaseous nitrogen was substituted for air to keep 5 vol. % of the oxygen density. The solvent recovery device 83 and the solvent condenser 82 were installed for condensing and collecting solvent in the casting chamber 81. The solvent condenser 82 had an exit or downstream end conditioned at −10 deg. C.

The separation panel 87d was disposed to prevent evaporative gas from directly impinging the casting bead or the cast film 16, and was positioned to keep fluctuation in the static pressure in the vicinity of the casting die 41 within a range from −1 Pa to +1 Pa during 5 seconds from the start of the casting. When the residual solvent amount Z0 of the solvent in the cast film 16 became down to 45 wt. % according to the dry base, the self-supporting cast film 18 was stripped from the casting support belt 44 by the stripping roller 89 while the stripping roller 89 supports the self-supporting cast film 18. Tension of stripping was 1×10² N per sq. mm (namely 1×10⁸ N per sq. meter). For the purpose of suppressing failure in the stripping, a stripping speed or stripping roller draw was adjusted in a range of 100.1-110% as high as a speed of the casting support belt 44. A film surface temperature of the self-supporting cast film 18 was measured, and found 15 deg. C. An average drying rate on the casting support belt 44 was 60 wt. % per minute as solvent amount according to the dry base. Solvent gas was obtained by the evaporation, and condensed by the solvent condenser 82 conditioned at −10 deg. C., and collected by the solvent recovery device 83. Water in the collected solvent was conditioned with a water content of 0.5% or less. The evaporative gas after removal of the solvent was heated again, and reused as evaporative gas for blowing.

The self-supporting cast film 18 was transported by rollers in the transition region 90 toward the tension drying chamber 45. Evaporative gas of 40 deg. C. was blown by the initial drying fan or blower 91 in the transition region 90 to the self-supporting cast film 18. Tension of 30 N was applied to the self-supporting cast film 18 during transport by the rollers in the transition region 90. Density of the solvent in the evaporative gas was kept equal to saturation density at the temperature of −10 deg. C.

### Example 1

### Step 8. Tentering, Drying and Slitting

The self-supporting cast film 18 upon entry in the tension drying chamber 45 was fed in the transport zones in the tension drying chamber 45 while retained by tenter clips on the web edges, and dried by evaporative gas. The tenter clips were cooled or thermally controlled by heat exchange medium of 20 deg. C. by flow through the conduits in those. A chain was used to transport tenter clips. Fluctuation in the speed of the sprocket of the chain was 0.5% or less. The transport zones 121-123 were defined inside the tension drying chamber 45. The air conditioners 141-143 conditioned temperature T1-T3 of evaporative gas for the transport zones 121-123 at respectively 120, 145 and 100 deg. C. The circulator circulated gas in the transport zones 121-123 and uniformized each of their zone conditions. The solvent recovery devices 151-153 operated to keep the density of solvent in the gas in the transport zones 121-123 at the saturated gas density in the condition of −10 deg. C. An average drying rate in the tension drying chamber 45 was 20 wt. % per minute as solvent amount according to the dry base. A stretch ratio or tenter driving draw from the stripping roller 89 to the upstream end of the tension drying chamber 45 was 102%.

In the tension drying chamber 45, the self-supporting cast film 18 with the residual solvent amount Z1 of 30-35 wt. % was moved into the first transport zone 121, and was preheated. Then the self-supporting cast film 18 with the residual solvent amount Z2 of 20 wt. % was moved into the second transport zone 122, and was subjected to drying. After this, the self-supporting cast film 18 with the residual solvent amount Z3 of 5 wt. % was moved into the third transport zone 123, and was subjected to drying.

In the tension drying chamber 45, the self-supporting cast film 18 was stretched and subjected to stress relaxation at the stretch ratio R1 of 30%, the stress relaxation ratio R2 of 5%, and the stretching speed V1 of 100% per minute. The stretching speed V1 was equal to the stretch ratio R1 per unit time.

For residual solvent amounts, Shimadzu GC-18A gas chromatography (manufactured by Shimadzu Corporation) was used to measure weights. A weight x was initial weight of the sampled film of the polymer film at the time of sampling. A weight y was subsequent weight of the sampled film after the drying. Residual solvent amount was calculated from the weights x and y. The sampled film was a piece of the self-supporting cast film or the polymer film 22 in the cut size of 7×35 mm.

Solvent gas in the tension drying chamber 45 was obtained by the evaporation, and condensed and liquefied at −10 deg. C., and collected for recovery. A condenser was used for the recovery, and conditioned with temperature of −8 deg. C. at its downstream end. Water in the collected solvent was conditioned with a water content of 0.5 wt. % or less, to reuse the solvent as evaporative gas. Then the polymer film 22 was transported out of the tension drying chamber 45.

Web edges of the polymer film 22 were slitted by the web edge slitter 46 within 30 seconds after moving from the tension drying chamber 45. An NT cutter in the web edge slitter 46 slitted the web edge portions being 50 mm wide. A cutter blower (not shown) moved the obtained web edge portions by blowing into the film crusher 93, which ground the web edge portions into chips or particles with an average area of 80 sq. mm. The chips were utilized as raw material for regeneration in producing the dope together with the TAC flake. In the dry atmosphere of the tension drying chamber 45, density of the oxygen was kept at 5 vol. %. To keep the density of the oxygen, gaseous nitrogen was used for substitution in air. There was a pre-drying chamber (not shown), which heated the polymer film 22 with evaporative gas of 100 deg. C. before drying in the downstream dryer 47.

### Example 1

### Step 9. Downstream Drying and Electrostatic Elimination

The downstream dryer 47 dried the polymer film 22 at a high temperature. Four zones were defined by splitting inside the downstream dryer 47. Blowers (not shown) or fans blew evaporative gas to the polymer film 22 at 120, 130, 130 and 130 deg. C. associated with respectively the zones in a downstream sequence. Tension applied to the polymer film 22 by the transport with the transport rollers 100 was 100 N/m. The polymer film 22 was dried for approximately 10 minutes until the amount of the residual solvent came down to 0.3 wt. %. Wrap angles of the transport rollers 100 were set 90 and 180 degrees. The transport rollers 100 were formed from aluminum or carbon steel, and coated with a hard chrome plating. A plurality of the transport rollers 100 included some prepared in a smoothly curved form, and others prepared in a matted form obtained by finish of blast. A range of film shakes due to rotations of the transport rollers 100 was 50 microns or less. Flexure of the transport rollers 100 at the tension of 100 N/m was regulated at an amount of 0.5 mm or less.

The solvent gas contained in the evaporative gas was collectively removed by adsorption of the adsorption solvent recovery device 101. An agent for adsorption was activated carbon. Desorption after the absorption was made by use of dry nitrogen. The collected solvent was conditioned to have water content equal to or less than 0.3 wt. %, and was reused for dope regeneration. Various gaseous substances were contained in the evaporative gas, including the gaseous plasticizer, gaseous UV absorbers, and other substances with a high boiling point in addition to the solvent gas. Those gaseous substances were removed by cool collecting operation of a cooler and a pre-adsorber, and were reused in a circulated manner. The adsorption and desorption were conditioned so as to set the content of volatile organic compounds (VOC) equal to or less than 10 ppm in the waste gas in the outdoor environment. Note that approximately 90 wt. % of solvent was collected according to the condensing method. The remainder of the solvent was collected by the adsorption method.

The polymer film 22 being dried was transported into a first fluidity adjusting chamber (not shown). Evaporative gas of 110 deg. C. was supplied in a transition region between the downstream dryer 47 and the first fluidity adjusting chamber. Air was supplied in the first fluidity adjusting chamber with temperature of 50 deg. C. and a condensation point of 20 deg. C. Then the polymer film 22 was transported into a second fluidity adjusting chamber (not shown) for preventing occurrence of a curl in the polymer film 22. Air was supplied directly to the polymer film 22 with temperature of 90 deg. C. and humidity of 70% RH.

### Example 1

### Step 10. Knurling and Winding

Then the polymer film 22 was transported into the cooler 48, and was gradually cooled to a level equal to or lower than 30 deg. C. The polymer film 22 was slitted again for web edge slitting in a slitter (not shown). The voltage of electrification of the polymer film 22 was conditioned by the static elimination bar 102 in a range equal to or higher than −3 kV and equal to or lower than +3 kV. While the polymer film 22 was transported, the knurling roller 103 knurled each of the web edge portions of the polymer film 22. The knurling was edge embossing at a width of 10 mm. A pressure of the knurling roller 103 was conditioned so as to obtain an average maximum height of the knurled pattern being 12 microns higher than an average thickness of the polymer film 22.

Then the polymer film 22 was transported into the winder 49. The winder 49 was kept conditioned at 28 deg. C., and 70% RH of humidity. An ion gas flow static eliminator (not shown) was installed so as to set potential of the polymer film 22 electrified in a range from −1.5 kV to +1.5 kV. The polymer film 22 being obtained was 80 microns thick, and 1,475 mm wide. A diameter of the winding roller 110 was 169 mm. Tension was sequentially controlled, and set at 300 N per meter at the initial step of the winding, and set at 200 N per meter at the end of the winding. The total length of the polymer film was 3,940 meters. With reference to the winding roller 110 of which a width of oscillation of the polymer film 22 was from −5 mm to +5 mm, a period of a fluctuation in the winding of the polymer film 22 was 400 meters. A pressure applied by the press roller 111 to the winding roller 110 was determined 50 N per meter. The polymer film 22 while being wound had temperature of 25 deg. C., contained 1.4 wt. % of water, and contained 0.3 wt. % of residual solvent. An average drying rate in the whole process was 20 wt. % per minute according to the dry base of solvent. As a result of observation, no wrinkle or looseness of the windings was found to occur. No offsetting of the windings occurred in the test of shock at 10 g (10 times normal gravity). Also, appearance of the roll of the polymer film was found agreeable.

Preservation was tested. The roll (not shown) of the polymer film 22 was preserved in a rack at 25 deg. C. with 55% RH for one (1) month. The polymer film 22 after this was observed in the same manner as described above. As a result, no change was found. No adhesions within the roll were found. No failure of stripping of the cast film 16 as a residue of the dope was found on the casting support belt 44 after casting of the polymer film 22.

### Examples 2-10

Example 1 was repeated with differences in that the temperature T2 of the second transport zone 122 was set respectively at 140, 130, 125, 120, 115, 110, 105, 103 and 101 deg. C.

### Comparative Examples 1-4

Example 1 was repeated with differences in that the temperature T2 of the second transport zone 122 was set respectively at 160, 150, 100 and 90 deg. C.

The retardation value Re in the in-plane direction of the polymer film 22 was 51 nm. The retardation value Rth in the thickness direction of the polymer film 22 was 195 nm. Methods of measuring those are hereinafter described.

[Evaluation]

1. Measurement of the Retardation Value (Re) in the in-Plane Direction

The polymer film 22 was cut with an area of 70×100 mm, and conditioned with humidity of 60% RH at 25 deg. C. for two (2) hours. After this, the automatic birefringence analyzer KOBRA-21DH (trade name) manufactured by Oji Scientific Instruments Co., Ltd. was used to measure the polymer film 22 at a wavelength of 632.8 nm in the vertical direction of the film surface, to calculate a retardation value Re according to the equation described above with values of refractive indexes and thickness. Note that the wavelength for use in the measurement was temporarily a value different from 632.8 nm.

2. Measurement of the Retardation Value (Rth) in the Thickness Direction

The polymer film 22 was cut with an area of 30×40 mm, and conditioned with humidity of 60% RH at 25 deg. C. for two (2) hours. An ellipsometer M150 (trade name) manufactured by JASCO Corporation was used to measure the polymer film 22 at 632.8 nm in the vertical direction and in a tilted state of the film surface, to calculate a retardation value Rth according to the equation described above.

In relation to the definition of the retardation, the thickness d of the polymer film was measured. An electronic micro meter produced by Anritsu Company was used, to measure the thickness of the polymer film 22 at a speed of 600 mm per minute. Measured data was recorded on a chart sheet at a chart speed 30 mm per minute and a reduction ratio of 1/20. A data curve of the data was measured by a measuring tool. An average thickness of the thickness was determined according to the measured data curve, and was obtained as thickness d of the polymer film 22.

For optical uniformity, a piece of the polymer film with a length of 1.5 meters and a full width was used as a sample. Two panel shaped polarizer elements were used and sandwiched the sample polymer film, and positioned with the polarization axes directed with a difference of 90 degrees. An X-ray film viewer having a light source was used, to observe irregularity of light when the light became incident upon a first polarizer element and exited from the second polarizer element. For the evaluation, the following grades were used.

A: No irregularity was found.

B: Local irregularity was found but so small that the polymer film was usable.

C: Considerable irregularity was found but so small that the polymer film was usable.

F: Remarkable irregularity was found so that the polymer film was not usable.

Conditions and results of Examples 1-10 and Comparative examples 1-4 are indicated in Table 1.

TABLE 1

| | Example 1 | Example 2 | Example 3 | Example 4 | Example 5 |
|---|---|---|---|---|---|
| Z0 (wt. %) | 45 | 45 | 45 | 45 | 45 |
| Z2 (wt. %) | 20 | 20 | 20 | 20 | 20 |
| Z0 − Z2 | 25 | 25 | 25 | 25 | 25 |
| (wt. %) | | | | | |
| T2 (deg. C.) | 145 | 140 | 130 | 125 | 120 |
| T3 (deg. C.) | 100 | 100 | 100 | 100 | 100 |
| T2 − T3 | 45 | 40 | 30 | 25 | 20 |
| (deg. C.) | | | | | |
| Results of | C | C | C | B | B |
| evaluation | | | | | |

| | | | | | Example |
|---|---|---|---|---|---|
| | Example 6 | Example 7 | Example 8 | Example 9 | 10 |
| Z0 (wt. %) | 45 | 45 | 45 | 45 | 45 |
| Z2 (wt. %) | 20 | 20 | 20 | 20 | 20 |
| Z0 − Z2 | 25 | 25 | 25 | 25 | 25 |
| (wt. %) | | | | | |
| T2 (deg. C.) | 115 | 110 | 105 | 103 | 101 |
| T3 (deg. C.) | 100 | 100 | 100 | 100 | 100 |
| T2 − T3 | 15 | 10 | 5 | 3 | 1 |
| (deg. C.) | | | | | |
| Results of | B | A | B | C | C |
| evaluation | | | | | |

| | Comparative | Comparative | Comparative | Comparative |
|---|---|---|---|---|
| | example 1 | example 2 | example 3 | example 4 |
| Z0 (wt. %) | 45 | 45 | 45 | 45 |
| Z2 (wt. %) | 20 | 20 | 20 | 20 |
| Z0 − Z2 | 25 | 25 | 25 | 25 |
| (wt. %) | | | | |
| T2 (deg. C.) | 160 | 150 | 100 | 90 |
| T3 (deg. C.) | 100 | 100 | 100 | 100 |
| T2 − T3 | 60 | 50 | 0 | −10 |
| (deg. C.) | | | | |
| Results of | F | F | F | F |
| evaluation | | | | |

### Example 11

Example 7 was repeated to produce polymer film with a difference in that the residual solvent amount Z2 of the self-supporting cast film was 15 wt. %.

### Example 12

Example 11 was repeated to produce polymer film with a difference in that the residual solvent amount Z0 of the self-supporting cast film was 50 wt. % and that the residual solvent amount Z2 of the self-supporting cast film was 20 wt. %.

### Comparative Example 5

Example 11 was repeated to produce polymer film with a difference in that the residual solvent amount Z0 of the self-supporting cast film was 50 wt. % and that the residual solvent amount Z2 of the self-supporting cast film was 25 wt. %.

### Comparative Example 6

Example 11 was repeated to produce polymer film with a difference in that the residual solvent amount Z0 of the self-supporting cast film was 55 wt. % and that the residual solvent amount Z2 of the self-supporting cast film was 30 wt. %.

### Example 13

Example 1 was repeated to produce polymer film with a difference in that the residual solvent amount Z0 of the self-supporting cast film was 50 wt. % and that the residual solvent amount Z2 of the self-supporting cast film was 20 wt. %.

### Comparative Example 7

Example 13 was repeated to produce polymer film with a difference in that the residual solvent amount Z0 of the self-supporting cast film was 40 wt. % and that the residual solvent amount Z2 of the self-supporting cast film was 15 wt. %.

### Comparative Example 8

Example 13 was repeated to produce polymer film with a difference in that the residual solvent amount Z0 of the self-supporting cast film was 35 wt. % and that the residual solvent amount Z2 of the self-supporting cast film was 10 wt. %.

### Example 14

Example 1 was repeated to produce polymer film with a difference in that the residual solvent amount Z0 of the self-supporting cast film was 46 wt. % and that the residual solvent amount Z2 of the self-supporting cast film was 24 wt. %.

### Comparative Example 9

Example 14 was repeated to produce polymer film with a difference in that the residual solvent amount Z0 of the self-supporting cast film was 44 wt. %.

### Comparative Example 10

Example 14 was repeated to produce polymer film with a difference in that the residual solvent amount Z0 of the self-supporting cast film was 42 wt. %.

Conditions and results of Examples 11-14 and Comparative examples 5-10 are indicated in Table 2.

TABLE 2

| | | | Compar- | Compar- | |
|---|---|---|---|---|---|
| | Example | Example | ative | ative | Example |
| | 11 | 12 | example 5 | example 6 | 13 |
| Z0 (wt. %) | 45 | 50 | 50 | 55 | 50 |
| Z2 (wt. %) | 15 | 20 | 25 | 30 | 20 |
| Z0 − Z2 | 30 | 30 | 25 | 25 | 30 |
| (wt. %) | | | | | |
| T2 (deg. C.) | 110 | 110 | 110 | 110 | 110 |
| T3 (deg. C.) | 100 | 100 | 100 | 100 | 100 |
| T2 − T3 | 10 | 10 | 10 | 10 | 10 |
| (deg. C.) | | | | | |
| Results of | A | A | B | B | A |
| evaluation | | | | | |

| | Compar- | Compar- | | Compar- | Comparative |
|---|---|---|---|---|---|
| | ative | ative | Exam- | ative | example |
| | example 7 | example 8 | ple 14 | example 9 | 10 |
| Z0 (wt. %) | 40 | 35 | 46 | 44 | 42 |
| Z2 (wt. %) | 15 | 10 | 24 | 24 | 24 |
| Z0 − Z2 | 25 | 25 | 22 | 20 | 18 |
| (wt. %) | | | | | |
| T2 (deg. C.) | 110 | 110 | 110 | 110 | 110 |
| T3 (deg. C.) | 100 | 100 | 100 | 100 | 100 |
| T2 − T3 | 10 | 10 | 10 | 10 | 10 |
| (deg. C.) | | | | | |
| Results of | B | B | A | C | C |
| evaluation | | | | | |

Therefore, it is possible in the solution casting to produce polymer film without unevenness of light when the condition for T2−T3 in Examples 1-14 is satisfied, as is observed from the results in Tables 1 and 2. In conclusion, the polymer film with high quality without unevenness of light and having good retardation values can be produced according to the invention.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A solution casting process comprising:
a flowing step of causing dope to flow on to a support, said dope containing polymer and solvent;
a cast film forming step of forming cast film from said dope on said support;
a stripping step of stripping said cast film having a self-supporting property to form self-supporting cast film;
a first drying step of stretching said self-supporting cast film, and applying first gas with temperature Ta to said self-supporting cast film containing said solvent, to evaporate said solvent therefrom;
a second drying step of, after said self-supporting cast film is stretched, applying second gas with temperature Tb to said self-supporting cast film containing said solvent, to evaporate said solvent therefrom for obtaining polymer film;
wherein said first and second drying steps satisfy a condition of:
0<Ta−Tb<50.

2. A solution casting process as defined in claim 1, wherein a first residual solvent amount of said self-supporting cast film in said stripping step is more than 40 wt. %;
a second residual solvent amount of said self-supporting cast film at a start of said first drying step of stretching and evaporation is less than 25 wt. %, and a difference between said first and second residual solvent amounts is more than 20 wt. %.

3. A solution casting process as defined in claim 2, wherein 3<Ta−Tb<30.

4. A solution casting process as defined in claim 3, wherein 5<Ta−Tb<15.

5. A solution casting process as defined in claim 2, further comprising a preheating step of preheating said self-supporting cast film between said stripping step and said first drying step.

6. A solution casting process as defined in claim 2, wherein said first and second drying steps are carried out in a tentering machine.

7. A solution casting process as defined in claim 6, wherein said tentering machine includes first, second and third zones arranged sequentially;
in said first zone, web edge portions of said self-supporting cast film in entry are supported for transport, and said first drying step is carried out in said second zone, and said second drying step is carried out in said third zone.

8. A solution casting process as defined in claim 7, further comprising a preheating step of preheating said self-supporting cast film in said first zone;
wherein a web width of said self-supporting cast film increases from a first width to a second width in said second zone, and is equal to said second width in said third zone.

9. A solution casting process as defined in claim 7, further comprising a blowing step of blowing gas to said self-supporting cast film after said stripping step and upstream from said tentering machine, to evaporate said solvent preliminarily.

10. A solution casting system comprising:
a casting die for causing dope containing polymer and solvent to flow;
a support, disposed movably under said casting die, for forming cast film from said dope being cast;
a stripping mechanism for stripping said cast film having a self-supporting property to form self-supporting cast film;
a first dryer for stretching said self-supporting cast film, and applying first gas with temperature Ta to said self-supporting cast film containing said solvent, to evaporate said solvent therefrom;
a second dryer for, after said self-supporting cast film is stretched, applying second gas with temperature Tb to said self-supporting cast film containing said solvent, to evaporate said solvent therefrom for obtaining polymer film;
wherein said first and second dryers satisfy a condition of:
0<Ta−Tb<50.

11. A solution casting system as defined in claim 10, wherein a first residual solvent amount of said self-supporting cast film on said stripping mechanism is more than 40 wt. %;
a second residual solvent amount of said self-supporting cast film upon entry to said first dryer for stretching and evaporation is less than 25 wt. %, and a difference between said first and second residual solvent amounts is more than 20 wt. %.

12. A solution casting system as defined in claim 11, wherein 3<Ta−Tb<30.

13. A solution casting system as defined in claim 12, wherein 5<Ta−Tb<15.

14. A solution casting system as defined in claim 11, comprising a tentering machine for containing said first and second dryers to stretch said self-supporting cast film.

15. A solution casting system as defined in claim 14, wherein said tentering machine includes first, second and third zones arranged sequentially;
in said first zone, web edge portions of said self-supporting cast film in entry are supported for transport, and said second zone has said first dryer, and said third zone has said second dryer.

16. A solution casting system as defined in claim 15, wherein said tentering machine further includes a preheater, contained in said first zone, for preheating said self-supporting cast film;
wherein a web width of said self-supporting cast film increases from a first width to a second width in said second zone, and is equal to said second width in said third zone.

17. A solution casting system as defined in claim 15, further comprising a fan or blower for blowing gas to said self-supporting cast film between said stripping mechanism and said tentering machine, to evaporate said solvent preliminarily.
